(19) United States
(12) Patent Application Publication
(10) Pub. No.: US 2023/0087094 A1
(43) Pub. Date: Mar. 23, 2023

(54) THREE-DIMENSIONAL COMPOSITE FABRIC

(71) Applicant: NICOLON CORPORATION D/B/A TENCATE GEOSYNTHETICS AMERICAS, Pendergrass, GA (US)

(72) Inventors: David Michael Jones, Buford, GA (US); Kevin King, Mount Airy, GA (US)

(21) Appl. No.: 17/929,686

(22) Filed: Sep. 3, 2022

Related U.S. Application Data
(60) Provisional application No. 63/244,910, filed on Sep. 16, 2021.

(51) Int. Cl. D03D 11/00; E02D 17/20; D03D 25/00; D04H 11/00

(52) U.S. Cl. CPC D03D 11/00; D03D 25/005; D04H 11/00; E02D 17/202; D10B 2401/02; D10B 2505/204

(57) ABSTRACT

The present invention is directed to a three-dimensional composite fabric including a three-dimensional woven fabric, and a nonwoven fabric arranged on a first, on a second side, or on both sides of the three-dimensional woven fabric, wherein the composite fabric retains at least 15% thickness at a compression of about 200 pounds per square foot (psf) to about 1000 pounds per square foot. Further, the present invention is directed to a method of making a three-dimensional composite fabric and a method of installing the three-dimensional composite fabric in a landfill.

### CROSS-REFERENCE TO RELATED APPLICATION

This application is a U.S. Nonprovisional Pat. Application which claims the benefit of U.S. Provisional Pat. Application No. 63/244,910, filed on Sep. 16, 2021, which is incorporated by reference herein in its entirety.

### TECHNICAL FIELD OF THE INVENTION

The present invention relates generally to composite fabrics, and more specifically to three-dimensional composite fabrics.

### BACKGROUND OF THE INVENTION

During the process of filling landfills with disposed waste, the waste in the landfills decomposes. By-products of the decomposition process are various gases and a toxic fluid run-off known as leachate. As the landfill is being filled, the waste is exposed to rainwater, which increases the amount of leachate. Thus, during the lifetime of a landfill, which may be several years, a large amount of toxic leachate is produced.

To avoid this leaching of toxics in soil, the landfill site must be carefully prepared to ensure that the leachate is not discharged into the ground. Additionally, dangerous gases such as methane that are released from the breakdown of the waste materials must also be controlled and managed. The gases from the breakdown of the solid waste of municipal solid waste (MSW) landfills are the third-largest source of human-related methane emissions in the United States, accounting for approximately 14 percent of these emissions in 2017.

At the same time, methane emissions from landfills represent a lost opportunity to capture and use a significant energy resource. When MSW is first deposited in a landfill, it undergoes an aerobic (with oxygen) decomposition. Landfill gas (LFG) is a natural byproduct of the decomposition of organic material in landfills. LFG is composed of roughly 50 percent methane (the primary component of natural gas), 50 percent carbon dioxide (CO₂), and a small amount of non-methane organic compounds.

A thin impermeable membrane above the clay base layer of the landfill acts as a barrier to the leachate. Suitable materials for the impermeable membrane include, for example, polyethylene liners. The leachate is normally then drained or pumped from collection points to a treatment plant or other secondary processing site for the treatment of the gases or leachate.

To protect against the gravel puncturing or locally overstressing the impermeable membrane, a permeable geotextile material can be provided between the membrane and the gravel layer. The geotextile material cushions the loading of the gravel on the impermeable membrane.

### SUMMARY OF THE INVENTION

In accordance with embodiments of the present invention, a three-dimensional (3D) composite fabric that can be employed in landfill application, and methods of making and using thereof, is described herein.

Embodiments of the present invention are directed to a three-dimensional composite fabric including a three-dimensional woven fabric including a first layer including monofilaments respectively woven in warp and fill directions; and an optional second layer including monofilaments respectively woven in warp and fill directions and having first and second sides; and a nonwoven fabric arranged on a first side, on a second side, or on both sides of the three-dimensional woven fabric; wherein the composite fabric retains at least 15% thickness at a compression of about 200 pounds per square foot (psf) to about 1000 pounds per square foot.

Other embodiments of invention are directed to a method of making a three-dimensional composite fabric, the method including arranging a nonwoven fabric on a first side, on a second side, or on both sides of a three-dimensional woven fabric, the three-dimensional woven fabric including a first layer including monofilaments respectively woven in warp and fill directions; and an optional second layer including monofilaments respectively woven in warp and fill directions and having first and second sides, the first layer being over and under woven through the second layer in a pattern such that the first layer has portions that face the first side of the second layer and portions that face the second side of the second layer, and cells being disposed on the first and second sides of the second layer and respectively defined by the pattern of the over and under weave of the first layer, and each cell defining a permeable, enclosed cavity.

Yet other embodiments of invention are directed to a method of installing the three-dimensional composite fabric, the method including arranging the three-dimensional composite fabric adjacent to a second three-dimensional composite fabric; heating portions of the three-dimensional composite fabric and the second three-dimensional composite fabric to join the three-dimensional composite fabric to the second three-dimensional composite fabric and form a joined three-dimensional composite fabric; and disposing the joined three-dimensional composite fabric in a landfill.

Yet other embodiments of invention is directed to a three-dimensional composite fabric including a three-dimensional woven fabric including a first layer including monofilaments respectively woven in warp and fill directions; and an optional second layer including monofilaments respectively woven in warp and fill directions and having first and second sides; and a nonwoven fabric arranged on a first side, on a second side, or on both sides of the three-dimensional woven fabric; wherein the three-dimensional composite fabric has a water transmissivity of at least 1 gallon per square feet per minute (g/sf/min) at 0.1 gradient at 200 pounds per square foot as measured in accordance with American Society for Testing and Materials International (ASTM International) Standard D 4716.

It is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the present invention. It is important, therefore, that the claims be regarded as including such equivalent constructions insofar as they do not depart from the spirit and scope of the present invention.

Other advantages and capabilities of the present invention will become apparent from the following description taken in conjunction with the accompanying drawings showing the elements and the various aspects of the present invention.

### BRIEF DESCRIPTION OF THE OF DRAWINGS

The disclosure below makes reference to the annexed drawings wherein:

FIG. 1 is a perspective view of a 3D composite fabric in accordance with embodiments of the present invention;

FIG. 2 is a schematic view of a 3D composite fabric in accordance with embodiments of the present invention;

FIG. 3 is another perspective view of a 3D composite fabric in accordance with embodiments of the present invention;

FIG. 4 is a side view of a 3D composite fabric with two layers of a nonwoven fabric in accordance with embodiments of the present invention;

FIG. 5 is an illustration in perspective view of a 3D composite fabric in accordance with embodiments of the present invention;

FIG. 6 is a schematic view and an enlarged view of a portion of a final cover system in accordance with embodiments of the present invention;

FIG. 7 is a schematic view of a track-on terrace system in accordance with embodiments of the present invention;

FIG. 8 is a graph of unit flow rate versus hydraulic gradient showing the results of hydraulic transmissivity testing using ASTM D 4716 testing method for a single layer nonwoven geotextile/ erosion control mat;

FIG. 9 is a graph of unit flow rate versus hydraulic gradient showing the results of hydraulic transmissivity testing using ASTM D 4716 testing method for a single layer nonwoven geotextile/ erosion control mat/ single layer nonwoven geotextile;

FIG. 10 is a graph of unit flow rate versus hydraulic gradient showing the results of hydraulic transmissivity testing using ASTM D 4716 testing method for a 6-ounce (oz) single-sided drainage composite;

FIG. 11 is a graph of unit flow rate versus hydraulic gradient showing the results of hydraulic transmissivity testing using ASTM D 4716 testing method for a 6-ounce (oz) double-sided drainage composite;

FIG. 12 is a graph of unit flow rate versus hydraulic gradient showing the results of hydraulic transmissivity testing using ASTM D 4716 testing method for a single layer nonwoven geotextile;

FIG. 13 is a graph of unit flow rate versus hydraulic gradient showing the results of hydraulic transmissivity testing using ASTM D 4716 testing method for a double layer nonwoven geotextile;

FIG. 14 is a graph of unit flow rate versus hydraulic gradient showing the results of hydraulic transmissivity testing using ASTM D 4716 testing method for a nonwoven geotextile/ white honeycomb woven mesh #58600; and

FIG. 15 is a graph of unit flow rate versus hydraulic gradient showing the results of hydraulic transmissivity testing using ASTM D 4716 testing method for a nonwoven geotextile/white honeycomb woven mesh #58600/ nonwoven geotextile.

### DETAILED DESCRIPTION OF THE INVENTION

There is a need to provide a fabric to be used in a liner system for various systems, including landfills and ponds, that can handle forces created by waste decomposition. There is also a need to provide a fabric design that can better withstand damage produced by heavy equipment or other external forces. There is yet further a need to provide a barrier liner design that is cost effective and complies with regulatory requirements. Although landfill design includes a many technological solutions, one noteworthy deficiency in landfill design is the inability to reliably and economically provide a liner system for landfill facilities.

In accordance with embodiments of the invention, a three-dimensional (3D) composite fabric and methods are provided for making and installing the 3D composite fabric. The 3D composite fabric of the present invention has a minimum water transmissivity of 1 gallon per square feet per minute (g/sf/min) at a 0.1 gradient at 200 pounds per square foot (psf), as measured in accordance with American Society for Testing and Materials International (ASTM International) Standard D 4716, retains at least 35% thickness at a compression of the composite of about 200 pounds per square foot, at least 20% thickness retention at a compression of the composite of about 500 pounds per square foot, and at least 15% thickness retention at a compression of the composite of about 1000 pounds per square foot, and is easy to install either on the top and/ or bottom of a various systems, including landfills and ponds.

In some embodiments, the 3D composite fabric is installed in the bottom of a pond. The 3D composite fabric allows for gases released from the breakdown of the waste materials to travel and escape.

In embodiments, the 3D composite fabric includes a three-dimensional woven fabric (a 3D woven fabric), a nonwoven fabric arranged on a first side, on a second side, or on both sides of the three-dimensional woven fabric, and optionally an adhesive arranged between the three-dimensional woven fabric and the nonwoven fabric. In other embodiments, the three-dimensional woven fabric includes a single woven layer.

In one or more embodiments, the three-dimensional woven fabric includes interwoven first and second layers. The first layer includes monofilaments respectively woven in warp and fill directions. Similarly, the second layer includes monofilaments respectively woven in warp and fill directions and having first and second sides, the first layer being over and under woven through the second layer in a pattern such that the first layer has portions that face the first side of the second layer and portions that face the second side of the second layer, the monofilaments in the warp direction of the first layer having a differential heat shrinkage characteristic greater than the monofilaments in the warp direction of the second layer, and cells being disposed on the first and second sides of the second layer and respectively defined by the pattern of the over and under weave of the first layer, and each cell defining a permeable, enclosed cavity. Further, the 3D composite fabric retains at least 35% thickness at a compression of the composite of about 200 pounds per square foot, at least 20% thickness retention at a compression of the composite of about 500 pounds per square foot, and at least 15% thickness retention at a compression of the composite of about 1000 pounds per square foot.

### Three-Dimensional Woven Fabric

In some embodiments, the three-dimensional woven fabric includes a single woven layer. Alternatively, in one or more embodiments, the three-dimensional woven fabric (the 3D fabric) includes interwoven first and second layers. The first layer includes monofilaments respectively woven in warp and fill directions. Similarly, the second layer includes monofilaments respectively woven in warp and fill directions and having first and second sides, the first layer being over and under woven through the second layer in a pattern such that the first layer has portions that face the first side of the second layer and portions that face the second side of the second layer, the monofilaments in the warp direction of the first layer having a differential heat shrinkage characteristic greater than the monofilaments in the warp direction of the second layer, and cells being disposed on the first and second sides of the second layer and respectively defined by the pattern of the over and under weave of the first layer, and each cell defining a permeable, enclosed cavity.

The 3D woven fabric has two principal directions, one being the warp direction and the other being the weft direction. The weft direction is also referred to as the fill direction. The warp direction is the length wise, or machine direction of the 3D fabric. The fill or weft direction is the direction across the 3D fabric, from edge to edge, or the direction traversing the width of the weaving machine. Thus, the warp and fill directions are generally perpendicular to each other. The set of yams, threads, or monofilaments running in each direction are referred to as the warp yarns and the fill yarns, respectively.

The 3D woven fabric can be produced with varying densities of yarns. This is usually specified in terms of number of the ends per inch in each direction, warp and fill. The higher this value is, the more ends there are per inch and, thus, the 3D fabric density is greater or higher. Although not required, the respective fabric densities of the first and second layers are sufficiently low in some embodiments such that adjacent monofilaments in the warp and fill directions do not contact one another. However, in other embodiments, either or both the first and second layers have a plurality of warp yarns contacting one another and/or a plurality of fill yarns contacting one another. Further, in some embodiments, the density of the first layer is between about 5 and about 50 ends/inch or yarns/inch in the warp and fill directions, independently. In other embodiments, the density of the first layer in the warp direction is 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 ends/inch. Likewise, in other embodiments, the 3D fabric density of the first layer in the fill direction is 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 yarns/inch. Similarly, the 3D fabric density of the second layer is between about 5 and about 50 ends/inch or yarns/inch in the warp and fill directions, independently. In other embodiments, the 3D fabric density of the second layer is between about 10 and about 50 ends/inch or yarns/inch in the warp and fill directions, independently. Yet, in other embodiments, the 3D fabric density of the second layer in the warp direction is 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 41, 42, 43, 44, 45, 46, 47, 48, 49, or 50 ends/inch. Likewise, in other embodiments, the 3D fabric density of the second layer in the fill direction is 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 41, 42, 43, 44, 45, 46, 47, 48, 49, or 50 yarns/inch.

The weave pattern of fabric construction is the pattern in which the warp yarns are interlaced with the fill yarns. A 3D woven fabric is characterized by an interlacing of these yarns. There are many variations of weave patterns commonly employed in the textile industry, and those of ordinary skill in the art are familiar with most of the basic patterns. While it is beyond the scope of the present application to include a disclosure of these multitude of weave patterns, the basic plain, twill, satin, honeycomb weave patterns can be employed with the present invention. However, such patterns are only illustrative, and embodiments of the present invention are not limited to such patterns. It should be understood that those of ordinary skill in the art will readily be able to determine how a given weave pattern could be employed in practicing embodiments of the present invention in light of the parameters herein disclosed.

The weaving process employed to form the 3D fabric is performed on any conventional textile handling equipment suitable for producing the 3D fabric of the present invention. Further, any of the aforementioned pattern weaves may be employed for either or both the first and second layers.

The first and second layers of the 3D woven fabric include monofilaments in the warp and fill directions. The geometrical cross-sectional shape of the yarns or monofilaments employed in the present invention can be of any shape. For example, the cross-sectional shape can be, but not limited to, round, oval, square, rectangular, trapezoidal, trilobal, multi-lobal, or other geometrically-shaped monofilaments.

In embodiments, at least a portion of the monofilaments used in 3D woven fabric are monofilament shrink yarns. In some embodiments, all of the monofilaments used in 3D woven fabric are monofilament shrink yarns. Alternatively, in some other embodiments, none of the monofilaments used in 3D woven fabric are monofilament shrink yarns. In one or more embodiments, the 3D woven fabric is either a single layer 3D woven fabric or a double layer 3D woven fabric.

Monofilament shrink yarns have a greater differential heat shrinkage characteristic compared to non-shrink yarns. In other words, shrink yarns have greater shrinkage than non-shrink yarns when exposed to the same heat and/or temperature conditions. Although non-shrink yarns can nominally shrink, such shrinkage is relatively insignificant as compared to the degree or amount of shrinkage of the shrink yarns at like heat and/or temperature conditions. Thus, the shrink yarns shrink more than the non-shrink yarns under the same heat and/or temperature conditions. Accordingly, upon being exposed to a sufficient duration of heating at a sufficient temperature, the monofilaments in the warp direction of the first layer shrink to a greater degree than the monofilaments in the warp direction of the second layer. This difference in shrinkage is due to the greater differential heat shrinkage characteristic of the monofilaments in the warp direction of the first layer with respect to the monofilaments in the warp direction of the second layer. Such shrinkage of the monofilaments in the warp direction of the first layer provides for a separation of a portion of the second layer from the first layer at the cells.

Alternatively, in some embodiments, the warp and fill monofilaments of the first layer include the same material. Alternatively, in other embodiments, both the warp and fill monofilaments of the first layer can be shrink yarns, even though such shrink yarns can include different polymers. In some other embodiments, the warp and fill monofilaments of the first layer include the same material and shrink yarns homogeneously together. Further, the warp and fill monofilaments of the second layer can be the same or different non-shrink yarns.

In one or more embodiments of the present invention, upon being exposed to sufficient heat and/or temperature, the monofilaments in the warp direction of the first layer shrink to a greater degree than the monofilaments of the second layer due to the greater differential heat shrinkage characteristic. In some embodiments, upon being exposed to sufficient heat and/or temperature conditions, the first layer includes polyethylene monofilament warp yarns or any other suitable monofilament warp yarn with a different shrink degree than a monofilament warp yarn of the second layer, and the second layer includes polypropylene monofilament warp yarns or any other suitable monofilament warp yarn with a different shrink degree than a monofilament warp yarn of the first layer; and the polyethylene monofilaments in the warp direction of the first layer shrink to a greater degree than the polypropylene monofilaments of the second layer due to the greater differential heat shrinkage characteristic of polyethylene. Such shrinkage of the monofilaments in the warp direction of the first layer provides for a separation of a portion of the second layer from the first layer at the cells.

The monofilaments are thermoplastic polymers in some embodiments. In other embodiments, the monofilaments include natural fibers. Such natural yarns should be selected on their ability to with withstand the heat and temperature of the tentering oven without being degraded or burned. Polymers that can be used to produce the 3D fabric of the present invention include, but are not limited to, polyamides (for example, any of the nylons), polyimides, polyesters (for example, high tenacity polyesters, polyethylene terephthalate, polybutylene terephthalate, and aromatic polyesters, for example, Vectran^{®}), polyacrylonitriles, polyphenylene oxides, fluoropolymers, acrylics, polyolefins (for example, low density polyethylene (LDPE), linear low density polyethylene (LLDPE), high density polyethylene (HDPE), co-polymers of polyethylene, polypropylene, and higher polyolefins), polyphenylene sulfide, polyetherimide, polyetheretherketone, polylactic acid (also known as polylactide), aramids (for example, para-aramids, which include Kevlar^{®}, Technora^{®}, Twaron^{®}, and meta-paramids, for example, Nomex^{®}, and Teijinconex^{®}), aromatic ether ketones, vinalon, and the like, and blends of such polymers which can be formed into microfilaments. Further, the monofilaments can include other agents, materials, dyes, plasticizers, etc. which are employed in the textile industry. It will be understood that any materials capable of producing fibers or microfilaments suitable for use in the instant fabric of the present invention fall within the scope of the present invention and can be determined without departing from the spirit thereof.

In one or more embodiments, the monofilaments are polyamides, polyimides, polyesters, polyacrylonitriles, polyphenylene oxides, fluoropolymers, acrylics, polyolefins, polyphenylene sulfide, polyetherimide, polyetheretherketone, polylactic acid, aramids, aromatic ether ketones, vinalon, or any combination thereof. Alternatively, the monofilaments include natural fibers. The monofilaments in the warp direction of the first layer includes polyethylene, and the monofilaments in the warp direction of the second layer includes polypropylene.

Any of the above polymers can be employed as "shrink" yarns," given a particular fabric construction. To recall, the shrink yarn shrinks at a lower temperature than the “non-shrink” yarn. The shrinkage properties are sufficiently different such that one yarn shrinks while the other does not.

According to one or more embodiments, the shrink and non-shrink yarns employed in the present invention further have the following properties:

| | Non-shrink Yarn | Shrink yarn |
|---|---|---|
| Denier | 250-2500 | 100-2500 |
| Tensile strength (lb) | 3 lb - 35 lb | 1 lb - 20 lb |
| Elongation at brake (%) | 5% - 35% | 10% - 80% |
| Shrink (%) | 4% - 8% | 16% - 20% * |

*Shrink percentage is tested in a shrinkage oven using 5-13 gram (g) weights (-tolerance +/- 0.1 g); using the 5 g weight with yarn deniers between 0-799, the 10 g weight with deniers between 800-1199, and the 13 g weight with deniers between 1200-1600, at 130° C. (±3° C. for shrinkage tester) for 3 minutes, at relative humidity 65% (±5%)

Tensile strength and elongation are determined in accordance with American Society for Testing and Materials' (ASTM) Standard Test Method D-2256.

### Nonwoven Fabric

The nonwoven fabric in the 3D composite fabric prevents small items such as soil and/or trash from the landfill from falling and filtering through the 3D composite and prevents clogging of the 3D composite fabric thereby preventing impediments within the 3D composite fabric that may hinder or reduce gas or water transmission. The nonwoven fabric of the 3D composite fabric is a web or fabric having a structure of individual, staple, or continuous fibers that are randomly interlaid and not woven, as in a woven or knitted fabric. Non-limiting examples of nonwoven fabrics for the 3D composite fabric include, but are not limited to, needle-punched webs, meltblown webs, spunbound webs, cross lapped webs, bonded carded webs, airlaid webs, wetlaid webs, coform webs, carded webs, hydraulically entangled webs, and any combination thereof. The nonwoven fabric includes polypropylene fibers, polyethylene fibers, natural fibers, synthetic fibers, a blend of natural and synthetic fibers, or a combination thereof

The fibers used to form the nonwoven fabric are natural fibers, synthetic polymeric fibers, or a combination thereof. In some embodiments, the synthetic polymeric fibers of the nonwoven fabric are polypropylene fibers, polyethylene fibers, or a combination thereof. In some embodiments, the fibers are staple fibers. According to one or more embodiments, the synthetic polymeric fibers of the nonwoven fabric are a homopolymer of polypropylene (PP), high density polyethylene (HDPE), medium density polyethylene (MDPE), low density polyethylene (LDPE), linear low-density polyethylene (LLPE), ultra-low density polyethylene (ULPE), or any combination thereof. According to some embodiments, the fibers of the nonwoven fabric are a blend of about 1% to about 40% polyethylene (e.g., HDPE, MDPE, LDPE, LLPE, or ULPE) and 99% to about 60% polypropylene. In some embodiments, the fibers of the nonwoven fabric are a blend of 95% polypropylene and 5% polyethylene. In some other embodiments, the fibers of the nonwoven fabric are made from a recycled polymer.

According to some embodiments, the synthetic polymeric fibers of the nonwoven fabric include, but are not limited to, polyamides (for example, any of the nylons), polyimides, polyesters (for example, high tenacity polyesters, polyethylene terephthalate, polybutylene terephthalate, and aromatic polyesters, for example, Vectran^{®}), polyacrylonitriles, polyphenylene oxides, fluoropolymers, acrylics, polyolefins (for example, low density polyethylene (LDPE), linear low density polyethylene (LLDPE), high density polyethylene (HDPE), co-polymers of polyethylene, polypropylene, and higher polyolefins), polyphenylene sulfide, polyetherimide, polyetheretherketone, polylactic acid (also known as polylactide), aramids (for example, para-aramids, which include Kevlar^{®}, Technora^{®}, Twaron^{®}, and meta-paramids, for example, Nomex^{®}, and Teijinconex^{®}), aromatic ether ketones, vinalon, and the like, and blends of such polymers which can be formed into microfilaments. Further, the fibers of the nonwoven fabric can include other agents, materials, dyes, plasticizers, etc. which are employed in the nonwoven industry. It will be understood that any materials capable of producing fibers or microfilaments suitable for use in the instant fabric of the present invention fall within the scope of the present invention and can be determined without departing from the spirit thereof.

Non-limiting examples of natural fibers for the nonwoven fabric include wood pulp fibers, plant-based fibers, cotton fibers, reconstituted cellulose fibers, or any combination thereof.

### Adhesive

The optional adhesive of the 3D composite binds the 3D woven fabric to the nonwoven fabric. Using an adhesive between the 3D woven fabric and the nonwoven fabric also enables the 3D composite to be a flexible interface, compared to an interface which is heat-bonded, which would not be flexible. The adhesive interface prevents the 3D composite from being an inflexible sheet like or monolithic structure.

The adhesive used should be flexible within all temperature ranges at which it is installed. A measure of the adhesive’s flexibility is its softening point, which is the temperature at which the material softens sufficiently to allow significant flow under a small stress. The softening point is measured by a Ring and Ball apparatus according to the ASTM D-2398 Test Method. In some embodiments, the adhesive has a softening point of about 150° F. to about 350° F. (°F). For example, in one or more embodiments, the adhesive has a softening point of about 170° F. to about 320° F., about 190° F. to about 300° F., about 210° F. to about 280° F., and about 230° F. to about 260° F. In other embodiments, the adhesive has a softening point of about 244° F. to about 252° F.

Non-limiting examples of adhesives for the 3D composite include a polyolefin adhesive (e.g., an amorphous polyolefin adhesive), a sprayable latex adhesive, a hot-melt adhesive, a thermoplastic polymer adhesive, an amorphous polyolefin adhesive, an ethylene vinyl acetate adhesive, a polypropylene adhesive, a polyethylene adhesive, a polypropylene and polyethylene blended adhesive, a polyvinyl acetate adhesive, an epoxy resin adhesive, an acrylate adhesive, an amorphous polyolefin (APO), a thermoplastic olefin (TPO), or any combination thereof. In some embodiments, the adhesive is an amorphous polyolefin adhesive.

### 3D Composite Fabric

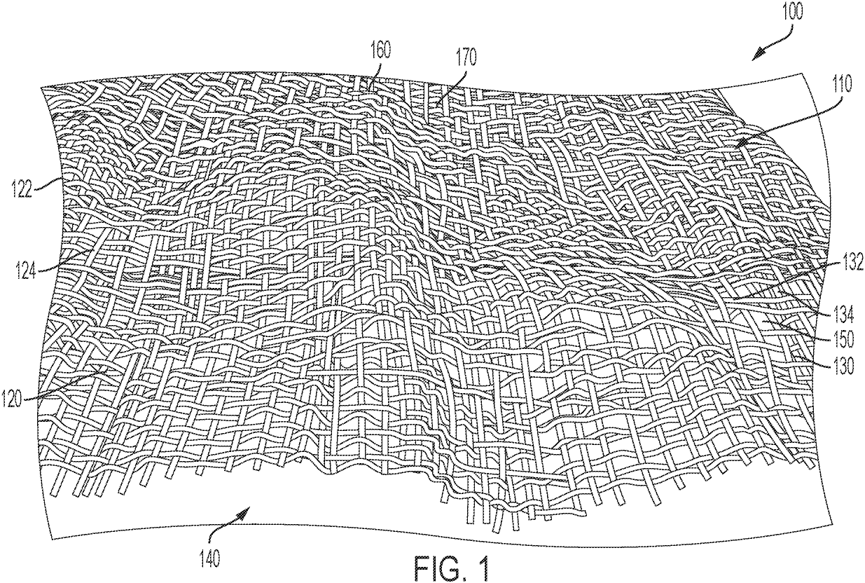

With reference to FIG. 1, a 3D composite fabric 100 includes a 3D fabric 110 adhered to a nonwoven fabric 140 with an adhesive (not shown). The 3D fabric 110 includes a first layer 120 and a second layer 130. First layer 120 includes warp yarn 122 that is woven together with weft or fill yarn 124. Similarly, the second layer 130 includes warp yarn 132 that is woven together with fill yarn 134. Moreover, first layer 120 is over and under woven through the second layer 130. During the tentering process, such as been exposed to hot water, steam, or infrared (IR) or convection heat in a tentering oven under sufficient heat and/or temperature conditions and duration, the shrink yarns shrink and the first layer 120 gathers and forms ridges 160 and valleys 170, as illustrated in FIG. 1. The pattern of the ridges 160 and valleys 170 depends on the weave of the second layer 130 and the over and under woven pattern of the first layer 120. Tentering causes respective portions of the first and second layers 120, 130 to space apart from one another. Such separation provides for the respective cells 150 to have enclosed, yet permeable, cavities capable. Further, the cells 150, ridges 160, and valleys 170 provide an irregular shape. Because the 3D fabric 110 has two layers of fabrics that are not in the same plane relative to one another after shrinking, the 3D fabric 110 provides for a horizontal network of yarns that provides a supportive structure. The rectangular pattern is provided for illustration only and should not be deemed limiting. Such patterns include, but are not limited to squares, rectangles, trapezoids, diamonds, circles, ovals, and the like.

Without limitation, the tentered 3D fabric 110 has a thickness, before compression, between about 150 mils and about 750 mils, for example, about 250 mils to about 700 mils, about 300 mils to about 650 mils, about 350 mils to about 600 mils, about 400 mils to about 550 mils, or about 450 mils to about 500 mils. Yet, in some embodiments, the tentered 3D fabric 110 have a thickness which is more than 200 mils and/or less than 750 mils. In other embodiments, the thickness of the tentered 3D fabric 110 is about 200, 250, 300, 350, 400, 450, 500, 550, 600, 650, 700, or 750 mils.

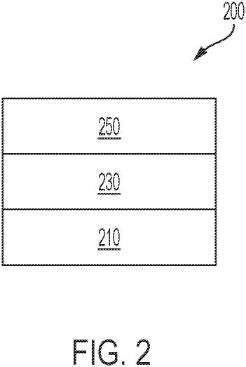

FIG. 2 shows a schematic view of a 3D composite fabric 200 that includes a 3D fabric 250 adhered to a nonwoven fabric 210 with an optional adhesive 230. In another embodiment, second layer of a nonwoven fabric (not shown) can be adhered to the top layer of the 3D fabric 250 using an adhesive (not shown) in-between. In yet another embodiment, a second 3D composite fabric (not shown) can be arranged above or below the 3D composite fabric 200 with an adhesive (not shown) in-between to form a plurality of a 3D composite fabric (not shown).

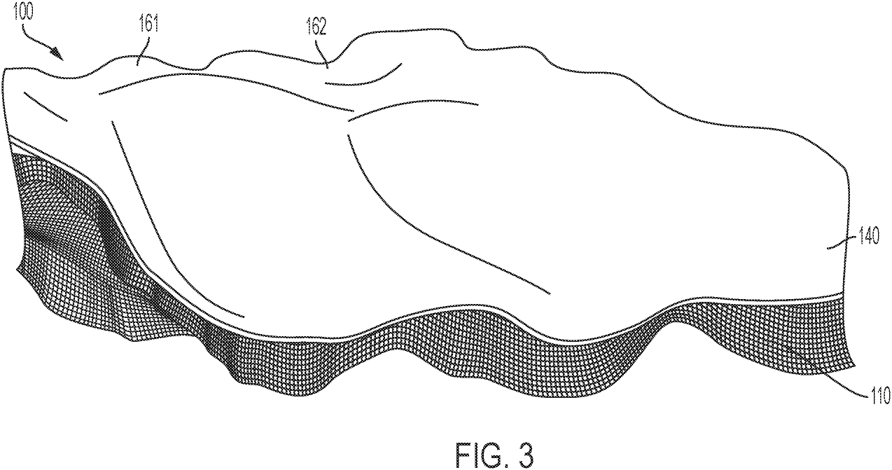

FIG. 3 shows a side view of the composite 3D fabric 100, with the 3D fabric 110 adhered to the nonwoven fabric 140 with the adhesive therebetween. In the embodiment shown in FIG. 3, the nonwoven fabric 140 is arranged on the 3D fabric 110. The nonwoven fabric 140 is adhered to the 3D fabric 110 by disposing an adhesive (not shown) between the 3D fabric 110 and the nonwoven fabric 140. The adhesive (not shown) is disposed on the 3D fabric 110, and then the nonwoven fabric 140 is disposed onto the adhesive; or the adhesive is disposed on the nonwoven fabric 140, and then the 3D fabric 110 is disposed on the adhesive.

As the 3D fabric 110 includes ridges 160 and valleys 170 (see FIG. 1), analogous valleys 162 and ridges 161 are formed on the nonwoven fabric 140, respectively, to provide an irregular shape that mirrors the 3D fabric. The ridges 160 of the 3D fabric 110 (in FIG. 1) result in the valleys 162 in the nonwoven fabric 140, and the valleys 170 of the 3D fabric (in FIG. 1) result in the ridges 161 in the nonwoven fabric 140.

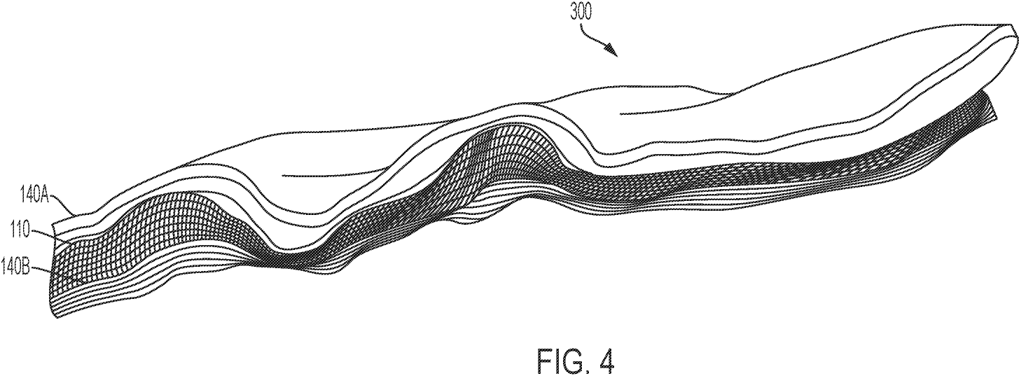

The nonwoven fabric 140 is adhered to one side of the 3D fabric 110 in some embodiments, as shown in FIG. 1 and FIG. 3. Yet, in other embodiments, nonwoven fabrics are adhered to both sides of the 3D fabric, as shown in FIG. 4. As shown in FIG. 4, a 3D fabric layer 110 is sandwiched between a top nonwoven fabric layer 140A (first nonwoven fabric) and a bottom nonwoven fabric layer 140B (second nonwoven fabric). An adhesive is arranged between the top nonwoven fabric 140A layer and the 3D fabric 110, as well as between the bottom nonwoven fabric layer 140B and the and the 3D fabric 110. The adhesive can be the same or different between the layers.

Referring again to FIG. 1, the warp yarn 122 of the first layer 120 of the 3D fabric 110 is a shrink yarn in some embodiments. In other embodiments, the fill yarn 124 of the first layer 120 of the 3D fabric 110 is a shrink yarn. Still, in other embodiments, the warp and fill yarns 122, 124 of the first layer 120 of the 3D fabric 110 are the same or different shrink yarn. In some embodiments, the warp and fill yarns 132, 134 of the second layer 130 are non-shrink yarns, and the non-shrink warp and fill yarns 132, 134 of the second layer 130 are the same or different. The independent shrink and non-shrink yarn systems are woven together so that the positioning of the shrink yarns dictate the properties of the finished fabric such as: thickness, bi-layer and multi-axial root support, opening sizes, strength, weight, stiffness, and width.

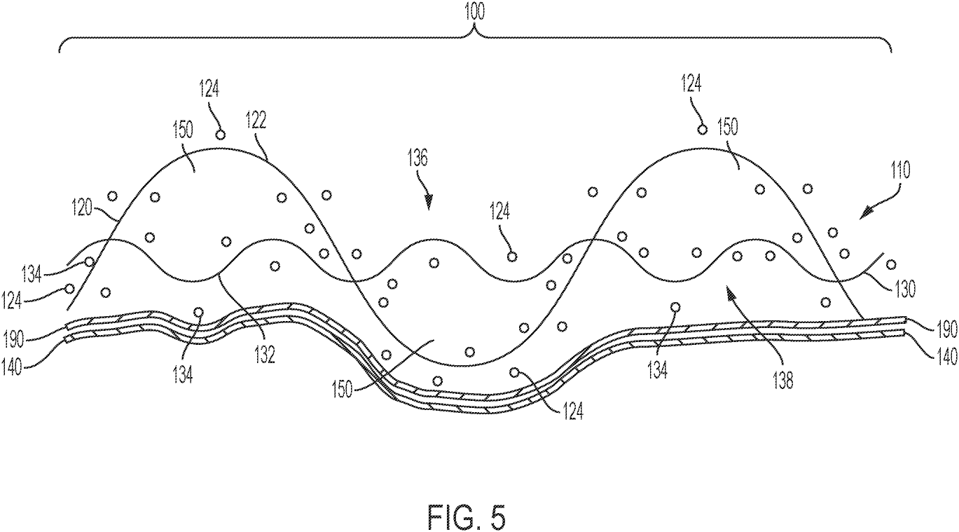

FIG. 5 shows an illustration of an exploded side view of a pre-tentered 3D composite fabric 100 in accordance with embodiments of the present invention. The 3D fabric 110 is arranged on the nonwoven fabric 140. An optional adhesive 190 is arranged between the nonwoven fabric 140 and the 3D fabric 110. As mentioned above, the first layer 120 of the 3D fabric 110 is over and under woven through the second layer 130, as illustrated in FIG. 5. That is, a portion of the first layer 120 faces the first side 136 of the second layer 130 and another portion of the first layer 120 faces the second side 138 of the second layer 130. This over and under weave is repeated and offset in the warp and fill directions to create various patterns or blocks on the first and second sides 136, 138 of the second layer 130.

As a result of the over and under weave patterns of the first layer 120, permeable, closed cells 150 are created within the portion of the first layer 120 facing the first side 136 of the second layer 130. Likewise, permeable, closed cells 150 are created within the portion of the first layer 120 facing the second side 138 of the second layer 130. The cells 150 are illustrated in FIG. 5.

Again, referring to FIGS. 1 and 5, the 3D composite fabric 100 includes a 3D fabric 110 with cells 150 in the bi-layer system that allow water to flow radially under high load so that water and leachate can escape to a collection point.

Following the weaving and arrangement process, the 3D fabric 110 is essentially flat. Prior to tentering, the 3D fabric 110 thickness largely depends on the thickness of the respective monofilaments employed to weave the first and second layers 120, 130. In some embodiments, the pre-tentered 3D fabric 110 has a thickness between about 20 mils and about 125 mils. In one or more embodiments, the pre-tentered 3D fabric 110 has a thickness of about or in any range between 20, 25, 30, 35, 40, 45, 50, 55, 60, 65, 70, 75, 80, 85, 90, 95, 100, 105, 110, 115, 120, and 125 mils. Yet, in other embodiments, the pre-tentered 3D fabric 110 has a thickness which is less than about 20 mils or greater than about 125 mils.

The 3D fabric 110 is then subjected to a heat setting or tentering process. For example, the untentered 3D fabric 110 is placed on a “bed” of open mesh fabric. Thereafter, the 3D fabric 110 is exposed to heat in a tenter oven by pulling the fabric through the hot air with sufficient tension necessary to pull the fabric through the oven. The 3D fabric 110 is allowed to “free-shrink.” That is, the 3D fabric 110 is not restrained by mechanical devices such as standard pins or clips. Typically, the 3D fabric 110 is processed through the tenter oven at temperatures of about 200° F. -about 275° F., for example when the shrink yarn is polyethylene and the non-shrink yarn is polypropylene. It is understood by one of ordinary skill in the art that the temperature range to be employed to tenter the 3D fabric 110 is dependent upon the polymer employed as the shrink yarn. Again, the non-shrink yarns are selected such that they do not shrink, or nominally shrink with respect to the shrink yarn, at the tentering temperature. Further, the tentering temperature range can be varied depending upon the desired thickness characteristics of the 3D fabric 110 and the dwell time of the 3D fabric 110 in the tenter oven. The purpose of the tentering process is to subject the multi-layered fabric to sufficient heat for a sufficient duration to permanently shrink the shrink yarn. As mentioned above, the shrinkage effect forces the non-shrink yarns to buckle. This creates designed shapes that form 3D structures. These structures withstand compression forces present in a various systems, including landfills and ponds.

After the above-described tentering process is conducted on the 3D fabric 110, the respective cells or 3-D cuspations 150 have a length in the warp direction from about 0.4 inches to about 1.3 inches. Similarly, the respective cells 150 have a width in the fill direction from about 0.40 inches to about 1.3 inches. In some embodiments, the respective cells or the 3-D cuspations 150 have a length and width dimension of 0.87 inches × 0.87 inches, respectively. It is readily apparent to one of ordinary skill in the art that the lengths and widths of the cells or the 3-D cuspations 150 of the 3D fabric 110 can be substantially the same or different depending upon the composite fabric density in the warp and weft directions, respectively. Further, it is also readily apparent to one of ordinary skill in the art that the cells or the or 3-D cuspations 150 of the 3D fabric 110 can differ in size and shape, again, based upon the fabric density in the warp and weft directions, respectfully.

In one or more embodiments, after the above-described tentering process is conducted on the 3D fabric 110, the distance between the first and second layers 120, 130 of given cell or 3-D cuspation 150 at the widest point therein is from about 50 mils to about 750 mils. In other embodiments of the present invention, the distance between the first and second layers 120, 130 of a given cell or a 3-D cuspations 150 at the widest point therein is from about 150 mils to about 350 mils. Yet, in other embodiments of the present invention the distance between the first and second layers of a cell or a 3-D cuspations 150 at the widest point therein is about 200 mils. Each cell or 3-D cuspations has a portion of the first layer 120 that is spaced apart from a portion of the second layer 130.

The 3D composite fabric provides various advantages for use in various systems, including landfills and ponds. The 3D composite fabric maintains a high percentage of its original thickness when compressed, which is desirable as it will need to be able to withstand considerable loads in various systems, including landfills and ponds. In one or more embodiments, the 3D composite fabric has a total thickness of about 150 mils to about 750 mils, for example, about 200 mils to about 700 mils, about 250 mils to about 650 mils, about 300 mils to about 600 mils, and about 400 mils to about 500 mils. For example, the 3D composite fabric has a thickness of about or in any range between 150, 200, 250, 300, 250, 400, 450, 500, 550, 600, 650, and 700 mils. Retention of a high percentage of its original thickness when compressed preserves lateral planes of the 3D composite, which allows water and gas flow even when the 3D composite is compressed.

In some embodiments, the 3D composite fabric retains at least 35% thickness at a compression of the composite of about 200 pounds per square foot (psf), for example, about 35% to about 95%, about 45% to about 95%, about 40% to about 90%, about 55% to about 85%, and about 60% to about 75% at a compression of about 200 pounds per square foot. For example, the 3D composite fabric retains % thickness of about or in any range between 35%, 40%, 45%, 50%, 55%, 60%, 65%, 70%, 75%, 80%, 85%, 90%, and 95% at a compression of about 200 pounds per square foot.

In other embodiments, the 3D composite fabric retains at least 20% thickness retention at a compression of the composite of about 500 pounds per square foot, for example, about 20% to about 85%, about 22% to about 75%, about 35% to about 85%, about 45% to about 75%, and about 55% to about 65% at a compression of about 500 pounds per square foot. For example, the 3D composite fabric retains % thickness of about or in any range between 20%, 25%, 30%, 35%, 40%, 45%, 50%, 55%, 60%, 65%, 70%, 75%, 80%, and 85% at a compression of about 500 pounds per square foot.

Still yet, in other embodiments, the 3D composite fabric retains at least 15% thickness retention at a compression of the composite of about 1000 pounds per square foot, for example, about 15% to about 70%, about 17% to about 67%, about 20% to about 65%, and about 25% to about 55% at a compression of about 1000 pounds per square foot. For example, the 3D composite fabric retains % thickness of about or in any range between 15%, 20%, 25%, 30%, 35%, 40%, 45%, 50%, 55%, 60%, 65%, and 70% at a compression of the composite of about 1000 pounds per square foot.

The 3D composite fabric has a high-water flow rate and air flow rate, which allow water (e.g., rainwater) and air (e.g., landfill generated gases from degradation of materials) to travel through towards collection sites. The structure of the 3D composite fabric includes many cells in different lateral planes for water and air to flow, both when the 3D composite fabric is compressed and not compressed. When a spacer fabric is under a load, the channels of the spacer fabric are compromised due to compression thereby limiting their capacity to laterally displace the leachate, gas, or water. The high flow rate of the 3D composite fabric allows the 3D composite fabric to maintain a suitable lateral flow when the 3D composite fabric is compressed or compromised under a load. In some embodiments, the 3D composite fabric has a water flow rate of about 0.01 gallons per minute/foot (gpm/ft) to about 15 gallons per minute/foot, as measured in accordance with American Society for Testing and Materials International (ASTM International) Standard D 4716. For example, the 3D composite fabric has a water flow rate of about 0.01 gpm/ft to about 12 gpm/ft, about 0.01 gpm/ft to about 9 gpm/ft, about 0.01 gpm/ft to about 6 gpm/ft, about 0.01 gpm/ft to about 3 gpm/ft, and about 0.01 gpm/ft to about 1 gpm/ft, as measured in accordance with ASTM International Standard D 4716.

The 3D composite fabric has an air flow rate of about 10 cubic feet per minute per square foot (cfm) to about 1000 cubic feet/minute per square foot as measured in accordance with American Society for Testing and Materials International (ASTM International) Standard D 737.

The single sided 3D composite fabric, with a single nonwoven adhered to one side, has an air flow rate of about 150 cubic feet per minute (cfm) to about 700 cubic feet per minute, as measured in accordance with American Society for Testing and Materials International (ASTM International) Standard D 737. For example, the single sided 3D composite fabric has an air flow rate of about 150 cubic feet per minute to about 650 cubic feet per minute, about 150 cubic feet per minute to about 600 cubic feet per minute, about 150 cubic feet per minute to about 550 cubic feet per minute, about 150 cubic feet per minute to about 500 cubic feet per minute, about 150 cubic feet per minute to about 450 cubic feet per minute, about 150 cubic feet per minute to about 400 cubic feet per minute, about 150 cubic feet per minute to about 300 cubic feet per minute, and about 150 cubic feet per minute to about 200 cubic feet per minute, as measured in accordance with ASTM International Standard D 737.

The double-sided 3D composite fabric has an air flow rate of about 50 cubic feet per minute to about 400 cubic feet per minute, as measured in accordance with American Society for Testing and Materials International (ASTM International) Standard D 737. For example, the double sided 3D composite fabric, with nonwoven fabrics adhered to both sides of the 3D fabric, has an air flow rate of about 50 cubic feet per minute to about 350 cubic feet per minute, about 50 cubic feet per minute to about 300 cubic feet per minute, about 50 cubic feet per minute to about 250 cubic feet per minute, about 50 cubic feet per minute to about 200 cubic feet per minute, about 50 cubic feet per minute to about 150 cubic feet per minute, about 50 cubic feet per minute to about 100 cubic feet per minute, and about 50 cubic feet per minute to about 75 cubic feet per minute, as measured in accordance with ASTM International Standard D 737.

The 3D composite fabric has a high transmissivity, which is a measure of water that flows horizontally across the fabric. Although some other 3D composite fabrics have thick 3D structures with high water and air flow rates, the 3D structure with high water and air flow alone does not necessarily translate to high transmissivity. A high rate of transmissivity is advantageous when the 3D composite is used in a landfill because it is desirable to have a continuous flow under a load. Without a rate of transmissivity, gases and/or liquids may get trapped in the fabric, which can cause leaks, settling, blockage, overflow, and other challenges attributed to the poor transmissivity.

The 3D composite fabric has a water transmissivity of at least 1 gallon per square feet per minute (g/sf/min) at about 0.1 gradient and about 200 pounds per square foot as measured in accordance with American Society for Testing and Materials International (ASTM International) Standard D 4716. For example, the 3D composite fabric has a water transmissivity of at least 1 gallon per square feet per minute at about 0.1 gradient at about 200 pounds per square foot normal load, as measured in accordance with ASTM International Standard D 4716. The purpose of the 3-D woven is to allow suitable drainage under load, and the purpose of the nonwoven is to provide separation from any landfill materials from clogging the 3-D woven and additionally load dissipation to the overall composite.

In an embodiment, the 3D composite fabric includes a shrinker fabric, a non-shrinker fabric, or a combination thereof. In another embodiment, the 3D composite fabric includes the shrinker fabric. In yet another embodiment, the 3D composite fabric includes the non-shrinker fabric. In yet another embodiment, the 3D composite fabric includes the combination of the shrinker fabric and the non-shrinker fabric.

In one or more embodiments, a three-dimensional composite fabric includes: a three-dimensional woven fabric including: a first layer including monofilaments respectively woven in warp and fill directions; and a second layer including monofilaments respectively woven in warp and fill directions and having first and second sides; and a nonwoven fabric arranged on a first side, on a second side, or on both sides of the three-dimensional woven fabric; wherein the three-dimensional composite fabric has a water transmissivity of at least 1 gallon per square feet per minute (g/sf/min) at 0.1 gradient at 200 pounds per square foot as measured in accordance with American Society for Testing and Materials International (ASTM International) Standard D 4716. In some embodiments, an adhesive is arranged between the three-dimensional woven fabric and the nonwoven fabric.

### Method of Making a 3D Composite Fabric

Hereinafter, methods of making a 3D composite fabric is described. The method includes: arranging a nonwoven fabric on a first side, on a second side, or on both sides of a three-dimensional woven fabric, the 3D woven fabric includes a first layer including monofilaments respectively woven in warp and fill directions; and a second layer including monofilaments respectively woven in warp and fill directions and having first and second sides, the first layer being over and under woven through the second layer in a pattern such that the first layer has portions that face the first side of the second layer and portions that face the second side of the second layer, the monofilaments in the warp direction of the first layer having a differential heat shrinkage characteristic greater than the monofilaments in the warp direction of the second layer, and cells being disposed on the first and second sides of the second layer and respectively defined by the pattern of the over and under weave of the first layer, and each cell defining a permeable, enclosed cavity. In some embodiments, the method further includes applying an adhesive to either the three-dimensional woven fabric or the nonwoven fabric; and adhering the 3D woven fabric to the nonwoven fabric such that the adhesive is arranged therebetween to form the 3D composite fabric.

According to some embodiments, the 3D composite fabric prepared using the above mentioned method retains at least 35% thickness at a compression of the composite of about 200 pounds per square foot, at least 20% thickness retention at a compression of the composite of about 500 pounds per square foot, and at least 15% thickness retention at a compression of the composite of about 1000 pounds per square foot, and each cell has a portion of the first layer that may be spaced apart from a portion of the second layer.

The monofilaments used for the 3D fabric in the method are polyamides, polyimides, polyesters, polyacrylonitriles, polyphenylene oxides, fluoropolymers, acrylics, polyolefins, polyphenylene sulfide, polyetherimide, polyetheretherketone, polylactic acid, aramids, aromatic ether ketones, vinalon, or any combination thereof. The monofilaments also include natural fibers. The monofilaments in the warp direction of the first layer include polyethylene and the monofilaments in the warp direction of the second layer include polypropylene.

The resulting 3D composite fabric retains about 35% to about 95% thickness at a compression of about 200 pounds per square foot; about 20% to about 85% thickness at a compression of about 500 pounds per square foot; and about 15% to about 70% thickness at a compression of about 1000 pounds per square foot.

The resulting 3D composite fabric has a water flow rate of about 0.01 gallons per minute/foot to about 15 gallons per minute/foot, as measured in accordance with ASTM International Standard D 4716. In embodiments, the 3D composite fabric has a water transmissivity of at least 1.0 gallon per square feet per minute (g/sf/min) at about 0.1 gradient and about 200 pounds per square foot as measured in accordance with American Society for Testing and Materials International (ASTM International) Standard D 4716.

The resulting three-dimensional composite fabric has an air flow rate of about 10 cubic feet per minute (cfm) to about 1000 cubic feet/minute, as measured in accordance with American Society for Testing and Materials International (ASTM International) Standard D 737. In one or more embodiments, the resulting single sided 3D composite fabric has an air flow rate of about 50 cubic feet per minute to about 700 cubic feet per minute as measured in accordance with ASTM International Standard D 737. In some embodiments, the resulting double sided 3D composite fabric has an air flow rate of about 50 cubic feet per minute to about 400 cubic feet per minute as measured in accordance with ASTM International Standard D 737.

Non-limiting examples of nonwoven fabrics for the 3D composite fabric include meltblown webs, spunbound webs, bonded carded webs, airlaid webs, wetlaid webs, coform webs, carded webs, and hydraulically entangled webs, needlepunch webs, or any combination thereof. According to one or more embodiments, the 3D composite fabric is a needlepunch staple fiber web. The nonwoven fabric includes polypropylene fibers, polyethylene fibers, natural fibers, synthetic fibers, a blend of natural and synthetic fibers, or a combination thereof.

The adhesive is a sprayable latex, a hot-melt adhesive, a thermoplastic polymer, an amorphous polyolefin adhesive a polyalphaolefin, an ethylene vinyl acetate, a polypropylene, a polyethylene, a polypropylene and polyethylene blend, a polyvinyl acetate, an epoxy resin, an amorphous polyolefin, an acrylate, an amorphous polyolefin (APO), a thermoplastic olefin (TMO), or a combination thereof. The adhesive has a softening point of about 150° F. to about 350° F., preferably from 244° F. to 252° F. For example, the adhesive has a softening point of about or in any range between 150° F., 170° F., 200° F., 220° F., 250° F., 270° F., 300° F., 320° F., and 350° F. A polyolefin adhesive is employed as an adhesive in the method.

The method affords the respective cells or 3-D cuspations that have a length in the warp direction of about 0.40 inches to about 1.3 inches and a width in the fill direction of about 0.40 inches to about 1.3 inches, and measurements of the length and width of a respective cell or 3-D cuspations are same or different.

The 3D woven fabric used in the method has a thickness of about 150 mils to about 750 mils, for example, about 150 to about 700, about 150 to about 600, about 150 to about 500, and about 150 to about 400 mils. For example, the 3D woven fabric used in the method has a thickness of about or in any range between 150, 200, 250, 300, 250, 400, 450, 500, 550, 600, 650, and 700 mils.

In one or more embodiments 3D composite includes a second nonwoven fabric arranged on a side opposite the first nonwoven fabric. Other additional layers of fabric, materials, or layers can be added above or below the 3D composite fabric.

Hereinafter, a method of installing the 3D composite fabric in a landfill or a pond or any suitable structure is described. The method includes arranging a first 3D composite fabric adjacent to a second 3D composite fabric; heating portions of the first 3D composite fabric and the second 3D composite fabric to join the first 3D composite fabric to the second 3D composite fabric and form a joined 3D composite fabric; and disposing the joined 3D composite fabric in various systems, including landfills and ponds that need such 3D composite fabric. For a pond, the method of installation can be used to install any suitable combination, for example, a first liner-the 3D composite fabric-a second liner, a fabric-a first liner-the 3D composite fabric-a second liner, a liner- the 3D composite fabric-a fabric, the 3D composite fabric-a liner, or combination thereof, but are not limited thereto.

In embodiments, during the installation of the joined 3D composite fabric, the joined 3D composite fabric is disposed at a top of the landfill and/or the joined 3D composite fabric is disposed at a bottom of the landfill.

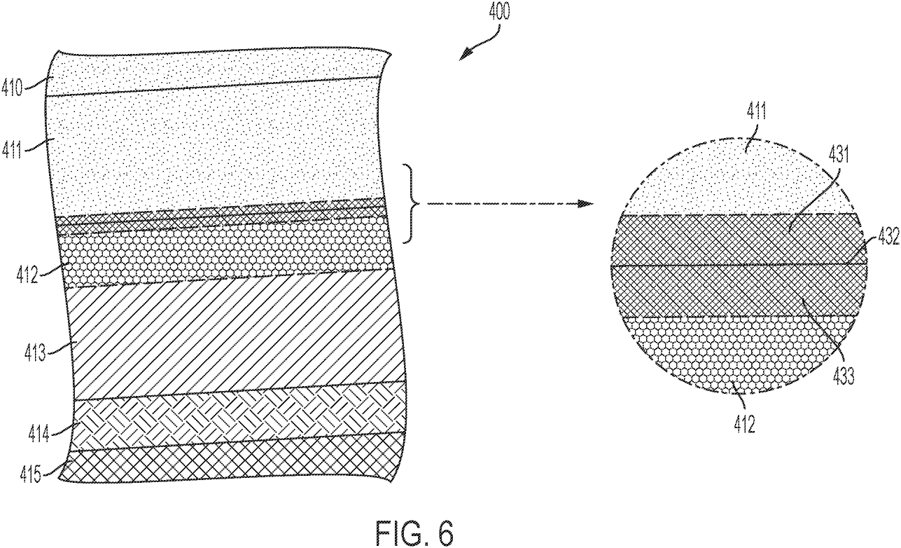

In other embodiments, as shown in FIG. 6, a final cover system disposed on the top of a landfill includes a solid waste 415 that is covered by a 6" soil layer 414, followed by a 12" intermediate cover layer 413, followed by a geocomposite section 430, and a cap foundation leveling layer 412. Above the cap foundation leveling layer 412 are arranged sequentially a 3-D laminated geocomposite 433, an impermeable geomembrane liner 432, and layer of a storm water geocomposite 431, followed by a 18" protective soil layer 411, and finally, a 6" layer of a topsoil 410.

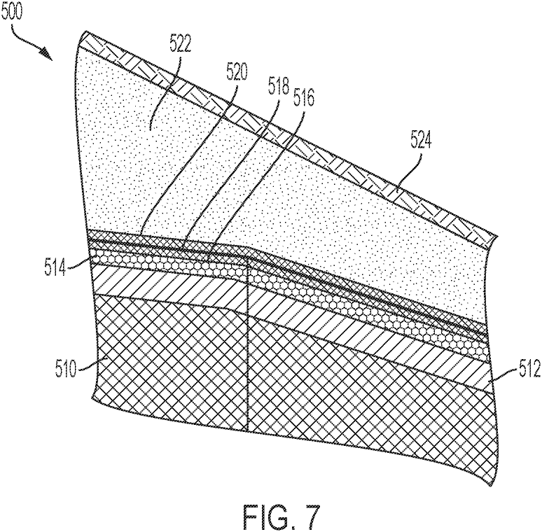

In yet another embodiment as shown in FIG. 7, a track-on terrace system includes an intermediate cover 512 disposed over a class I waste 510, followed by a 6" cap foundation 514; a 3D laminated geocomposite 516, an impermeable geomembrane liner 518, and a stormwater geocomposite 520 are disposed over the cap foundation 514 sequentially followed by a 18" cap protective layer 522, and a topsoil and vegetation 524.

Pieces of the 3D composite fabric are joined by a wedge welding, wherein the wedge weld strength is about 50 pound per inch (lb/in) to about 125 pound per inch when tested according to ASTM D4884 test method. The use of wedge welding to join pieces of the 3D composite fabric provides various advantages for landfill applications. For example, the resulting joined composites are homogeneous, monolithic and continuous/ seamless, less stiff, and less thick, which are therefore stronger than fabrics joined by other methods that include mechanical fasteners such as labor-intensive zip ties placed at every 3 feet to 15 feet. Further, the installation time is reduced, and labor costs to install the fabric are lowered. These advantages result in an improved, simple, and more cost-effective process for installation of the fabric.

Hereinafter, a 3D composite fabric according to embodiments are described in detail with reference to Examples, which are not to be construed as limiting.

### EXAMPLES

### General Information

3D composite fabrics were prepared and in accordance with embodiments of the present invention. Table 1 shows description of various composite fabrics used for testing.

Table 1

Description for various composite fabrics

| No. | Composite Fabric | Description |
|---|---|---|
| 1 | KEC1200 | 18 osy 100 den fiber needled to HP570 woven fabric |
| 2 | 160N | 6 osy Polypropylene (PP) needle punch nonwoven (NW) |
| 3 | KEC1200/NW/1 | KEC1200 with a single layer of 160N |
| 4 | TM13C | 3-D woven fabric utilizing shrinker monofilament yarns |
| 5 | SFM2000 | Same as KEC but stitched into pillows for containing sand (that is, SFM is stitched and KEC |
| | | is not); in SFM2000G and SFM2000B, ‘G’ is green fiber and ‘B’ is beige fiber respectively |
| 6 | 58600 | 3-D honeycomb woven with 20 mil monofilament yarn |
| 7 | 58600/NW/1 | 58600 with a single layer of 160N |
| 8 | 58600/MW/2 | 58600 with a double layer of 160N on each side |
| 9 | 58209 | 3-D honeycomb woven with 12 mil monofilament yarn |
| 10 | S600 | 6 osy PP needlepunch nonwoven (like 160N) |
| 11 | S2400 | 24 osy osy needlepunch nonwoven |
| 12 | S3200 | 32 osy needlepunch nonwoven |
| 13 | TM13 | 3-D cuspated woven with 18 mil and 20 mil non shrinker yarns and 10 mil shrinker yarns |
| 14 | TM13C/NW/1 | TM13C with a single layer of 160N |
| 15 | TM13C/NW/2 | TM13C with a double layer 160N on each side |
| 16 | DR11 | Woven composite that is stitched in layers: style HP280a on either side of an FW505 |
| 17 | DR12 | DR 11 with 2 layers of FW505 |
| 18 | DR13 | DR 11 with 3 layers of FW505 |
| 19 | 24 osy | PP needle punch 24 ounces per square yard NW |
| 20 | 32 osy | Same as 24 osy but with 32 osy |
| 21 | FW505 | 12 mono warp and fill high through plane water flow 150 g/sf/min Filterweave |
| 22 | HP280a | Woven monofilament warp and fibrillated tape in a 2/2 single pick twill |

Transmissivity is defined as shown in Equation 1,

$$θ = \frac{q}{w i}$$

wherein in Equation 1,
Θ = transmissivity in m²/s;
w = test specimen width (m);
q = flow rate in m³/sec; and
i = hydraulic gradient (no unit).

When transmissivity is reported in SI units on the left side, and imperial units are used on the right side of the Equation 1, a conversion factor has to be added to Equation 1 as shown in the Equation 2.

$$Θ = 0.00020697 q / w i$$

wherein in Equation 2,
Θ = transmissivity in m²/s;
w = test specimen width (ft), in standard testing (ATSM D 4706), w = 1 ft);
q = flow rate in gal/min; and
i = hydraulic gradient (no unit)

Therefore, a transmissivity flow rate of at least 1 gallon per square foot per minute (g/sf/min) at 0.1 gradient at 200 pounds per square foot as measured in accordance with American Society for Testing and Materials International (ASTM International) Standard D 4716 in m²/sec is,

$$1 \text{x 0} \text{.00020697/0} \text{.1 = 2} {\text{.07x10}}^{\text{-} 3} {\text{m}}^{2} \text{/sec}$$

### Example 1

Table 2 shows the percentage of thickness retained by 3D composite fabrics under 200, 500, and 1000 pounds per square foot compression. Wherein “osy” means ounces per square yard.

Table 2

% thickness maintained of 3D composite fabrics on compression

| | 58600 | 58209 | TM13C | TMC13C/NW/2 |
|---|---|---|---|---|
| | Honeycomb single layer woven with 20 mil yarns | Honeycomb single layer woven with 12 mil yarns | | |
| At 200 psf compression | | | | |
| Original Thickness | 230 | 93 | 419 | 471 |
| Thickness under load | 152 | 70 | 169 | 288 |
| % Thickness Retained | 66% | 75% | 40% | 61% |
| At 500 psf compression | | | | |
| Original Thickness | 234 | 91 | 412 | 471 |
| Thickness under load | 99 | 58 | 91 | 182 |
| % Thickness Retained | 42% | 63% | 22% | 38% |
| At 1000 psf compression | | | | |
| Original Thickness | 207 | 93 | 403 | 448 |
| Thickness under load | 65 | 49 | 69 | 115 |
| % Thickness Retained | 31% | 52% | 17% | 25% |

Table 2 (continued).

| | TM13C/NW/1 | SFM2000 | 160N |
|---|---|---|---|
| | | 18 osy needle punch NW needled to a single layer woven | 6 osy needle punch nonwoven |
| At 200 psf compression | | | |
| Original Thickness | 554 | 255 | 113 |
| Thickness under load | 325 | 228 | 79 |
| % Thickness Retained | 58% | 89% | 69% |
| At 500 psf compression | | | |
| Original Thickness | 522 | 298 | 112 |
| Thickness under load | 214 | 220 | 64 |
| % Thickness Retained | 41% | 73% | 57% |
| At 1000 psf compression | | | |
| Original Thickness | 513 | 295 | 114 |
| Thickness under load | 109 | 198 | 63 |
| % Thickness Retained | 21% | 67% | 55% |

As shown in Table 2 the percentage of thickness retained by 3D composite fabrics under 200, 500, and 1000 pounds per square foot varies according to the type of fabric and the amount of load. Results from Table 2 illustrate that just putting together a woven and nonwoven fabrics together is not enough to achieve a desirable % thickness retained for satisfactory radial transmission (for example, TMC13/NW/2 and TMC/NW/1). The inventors surprisingly and unexpectedly discovered that by combining a woven and nonwoven fabrics that retain high voids after compression allows to achieve improved radial transmission (for example, SFM2000 and 160N).

### Example 2

Tables 3-7 show transmissivity testing of 3D composite fabrics, as measured in accordance with ASTM International Standard D 4716. Table 3 shows transmissivity testing data for various composite fabrics under various compression pressures, as measured in accordance with ASTM International Standard D 4716. Wherein “osy” means ounces per square yard.

Table 3

Transmissivity of 3D composite fabrics

| Property | 24 osy PP NW | | 32 osy PP NW | | 58209 Black “Thin” Honeycomb Mesh | | 58600 White “Thick” Honeycomb Mesh | |
|---|---|---|---|---|---|---|---|---|
| | | Flow Rate (gpm/ft) | | Flow Rate (gpm/ft) | | Flow Rate (gpm/ft) | | Flow Rate (gpm/ft) |
| Normal Stress (psf) | 200 | | 200 | | 200 | | 200 | |
| Gradient | 0.05 | 0.08 | 0.05 | 0.10 | 0.05 | --- | 0.05 | --- |
| | 0.10 | 0.16 | 0.10 | 0.19 | 0.10 | 0.24 | 0.10 | 1.10 |
| | 0.33 | 0.46 | 0.33 | 0.58 | 0.33 | --- | 0.33 | --- |
| | 0.50 | 0.66 | 0.50 | 0.83 | 0.50 | 0.87 | 0.50 | 3.21 |
| | 1.00 | 1.15 | 1.00 | 1.50 | 1.00 | 1.43 | 1.00 | 5.02 |
| Normal Stress (psf) | | | | | 1000 | | 1000 | |
| | | | | | 0.1 | 0.04 | 0.1 | 0.07 |
| | | | | | 0.5 | 0.26 | 0.5 | 0.29 |
| | | | | | 1.0 | 0.48 | 1.0 | 0.50 |

Table 3 shows that the thinner woven 3-D fabric, 58209, fails to meet the desired 1 gallon per minute per square feet at 0.1 gradient at 200 pounds per square foot. The thicker 3-D fabric, 58600, does meet the desired 1 gallon per minute per square feet at 0.1 gradient at 200 pounds per square foot. However, as shown in Table 18 below, when combining the thicker 3D woven fabric, 58600, to a nonwoven, the transmissivity values are significantly lower than TM13C/NW/1 and TM13C/NW/2. As shown in Tables 17 and 18, the flow rate for 58600/NW/2 falls below the desired 1 gallon per minute per square feet at 0.1 gradient at 200 pounds per square foot. Additionally, the nonwoven fabrics, when tested by themselves fail, to achieve desirable radial transmission as they fall well below the desired 1 gallon per minute per square feet (gpm/ft) at 0.1 gradient at 200 pounds per square foot (psf). These results indicate that when a 3D woven mesh is added to nonwovens specified for a landfill use, they will also have results below 1.0 gpm under these conditions and fail the transmissivity test unless the 3-D fabric maintains sufficient voids under load. Further, TM13C demonstrates improved radial flow under loading conditions, however, other woven fabrics like DR11, DR12, and DR13, as shown in Tables 5 and 6, with a very high radial water flow layered with the intent to create sufficient void spacing, fail to achieve the desired 1 gallon per minute per square feet at 0.1 gradient at 200 pounds per square foot.

Table 4 shows transmissivity testing data for 3D composite fabric, KEC1200, with a nonwoven fabric on one side and on both sides (NA/1 and NW/2) at 0.1 gradient at 200 pounds per square foot, as measured in accordance with ASTM International Standard D 4716.

Table 4

Transmissivity of 3D composite fabrics

| Material(s) | KEC1200/NW/1 | | KEC1200/NW/2 | |
|---|---|---|---|---|
| | | Flow Rate (gpm/ft) | | Flow Rate (gpm/ft) |
| Normal Stress (psf) | 200 | | 200 | |
| Gradient | 0.10 | 0.06 | 0.10 | 0.07 |

KEC is a composite made from fiber that is 15x the fiber diameter that is in 160N. This would force the void spacings to be much greater. The fabric is then a high flow woven. However, as shown in Table 4, the transmissivity data was not favorable to the intended goal compared to the inventive composite. Under the same test conditions and loading, the void spacings of KEC1200, even with larger denier fiber, closed significantly and hindered radial water flow.

Table 5 shows transmissivity testing data for various composite fabrics under various compression pressures, as measured in accordance with ASTM International Standard D 4716. In Table 5, DR 11 is a 3D composite stitched together that has one woven mono/mono single layer filter fabric, FW505, in the middle of HP280a, a mono warp and fibrillated tape weft. DR12 is the same as DR11, except it has two layers of FW505 in the middle. A cushion is a rubber gasket that is typically used unless it interferes with the sample preparation within the test limits and allowances. As shown in Table 5, the data with cushion or without cushion is usually very similar.

Table 5

Transmissivity of 3D composite fabrics

| Material(s) | DR11 | | | | DR12 | | | |
|---|---|---|---|---|---|---|---|---|
| | WITHOUT CUSHION LAYER | | WITH CUSHION LAYER | | WITHOUT CUSHION LAYER | | WITH CUSHION LAYER | |
| | | Flow Rate (gpm/ft) | | Flow Rate (gpm/ft) | | Flow Rate (gpm/ft) | | Flow Rate (gpm/ft) |
| Normal Stress (psf) | 20 kPA (418 psf) | | 20 kPA (418 psf) | | 20 kPA (418 psf) | | 20 kPA (418 psf) | |
| Gradient | 0.10 | --- | 0.10 | --- | 0.10 | --- | 0.10 | --- |
| | 1.00 | 0.81 | 1.00 | 0.62 | 1.00 | 1.09 | 1.00 | 0.83 |
| Normal Stress (psf) | 200 kPA (4177 psf) | | 200 kPA (4177 psf) | | 200 kPA (4177 psf) | | 200 kPA (4177 psf) | |
| | 0.1 | --- | 0.1 | --- | 0.1 | --- | 0.1 | --- |
| | 1.0 | 0.33 | 1.0 | 0.18 | 1.0 | 0.45 | 1.0 | 0.23 |

As shown in Table 5, DR11 and DR12 are high flow wovens made into a composite with the expectation of having high transmissivity at 0.1 gradient at 200 psf. However, as shown in Table 5, it was not measurable at 0.1 gradient and even at 1.0 gradient the composite still did not have adequate flow rate for the application in question (that is, at least 1 gallon per minute per square feet at 0.1 gradient at 200 pounds per square foot). Table 5 illustrates that thicker fabrics that are supposed to demonstrate satisfactory transmissivity under load do not necessarily perform well, and thickness or retention of thickness is not the only criteria for a suitable fabric that gives improved transmissivity of at least 1 gallon per minute per square feet (gpm/ft) at 0.1 gradient at 200 pounds per square foot (psf).

Table 6 shows transmissivity testing data for various composite fabrics without any adhesive under various compression pressures, as measured in accordance with ASTM International Standard D 4716. DR13 is the same as DR11 mentioned above, except it has three layers of FW505 sandwiched between HP280a on both sides (see Table 1).

Table 6

Transmissivity of 3D composite fabrics

| Material(s) | DR13 | | | | TM13C/NW/1 (no adhesive) | | TM13C/NW/2 (no adhesive) | |
|---|---|---|---|---|---|---|---|---|
| | WITHOUT CUSHION LAYER | | WITH CUSHION LAYER | | | | | |
| | | Flow Rate (gpm/ft) | | Flow Rate (gpm/ft) | | Flow Rate (gpm/ft) | | Flow Rate (gpm/ft) |
| Normal Stress (psf) | 20 kPA (418 psf) | | 20 kPA (418 psf) | | 200 | | 200 | |
| Gradient | 0.10 | --- | 0.10 | --- | 0.10 | 2.50 | 0.10 | 1.90 |
| | 0.50 | | 0.50 | | 0.50 | 6.80 | 0.50 | 5.40 |
| | 1.00 | 1.78 | 1.00 | 1.29 | 1.00 | 10.40 | 1.00 | 8.30 |
| Normal Stress (psf) | 200 kPA (4177 psf) | | 200 kPA (4177 psf) | | - | | | |
| | 0.1 | --- | 0.1 | --- | | | | |
| | 1.0 | 0.72 | 1.0 | 0.62 | | | | |

As shown in Table 6, DR13 is a high flow woven made into a composite with the expectation of having high transmissivity at 0.1 gradient at 200 psf. However, as shown in Table 6, it was not measurable at 0.1 gradient and even at 1.0 gradient the composite still did not have a flow rate comparable to TM13C/NW/1 (with a single NW layer) or TM13C/NW/2 (with a double NW layer). Table 6 illustrates again that thicker fabrics that are supposed to demonstrate satisfactory transmissivity under load do not necessarily perform well, and thickness or retention of thickness is not the only criteria for a suitable fabric that gives improved transmissivity of at least 1 gallon per minute per square feet (gpm/ft) at 0.1 gradient at 200 pounds per square foot (psf).

Table 7 shows transmissivity testing data for various 3D composite fabrics with adhesives under various compression pressures, as measured in accordance with ASTM International Standard D 4716. TM13C with a single or double NW layer was tested without and with adhesive, as shown in Table 6 and 7 respectively, to evaluate if use of adhesive produce any statistically significant change in the flow rate.

Table 7

Transmissivity of 3D composite fabrics

| Material(s) | TM13C/NW/1 (with adhesive) | | TM13C/NW/2 (with adhesive) | |
|---|---|---|---|---|
| | | Flow Rate (gpm/ft) | | Flow Rate (gpm/ft) |
| Normal Stress (psf) | 200 | | 200 | |
| Gradient | 0.10 | 2.95 | 0.10 | 1.54 |
| | 0.50 | 8.08 | 0.50 | 4.68 |
| | 1.00 | 12.11 | 1.00 | 7.26 |

Tables 6 (without adhesive) and 7 (with adhesive) show that the use of adhesives for a single layer 3D composite fabric as well as for a double layer 3D composite fabric shows no real difference in the flow rate, that is, the use of adhesives does not impede the flow rate. The use of adhesives is to adhere woven and nonwoven layers together and keep them from potentially separating where the nonwoven layer may slide and concentrate in an area leaving the 3D composite fabric exposed, the exposed 3D composite fabric may get clogged and may no longer transmit gas and moisture.

### Example 3

Table 8 and 9 show the adhesive strength for a single and double sided (two sided) nonwoven 3D composite fabrics, as measured using a peel test in accordance with ASTM International Standard D 4541.

Table 8

Adhesive strength of single and double sided nonwoven 3D composite fabrics in accordance with ASTM International Standard D 4541

| | | | Lab Weight (ounces per square yard (osy)) | | | | | |
|---|---|---|---|---|---|---|---|---|
| Sample ID | TM13C.NW/1 or NW/2 | Adhesive Weight (osy) | Sample #1 | Sample #2 | Sample #3 | Sample #4 | Sample #5 | ROLL AVG |
| 1 | NW/1 | 1 osy | 20.36 | 22.20 | 21.11 | 20.96 | 22.37 | 21.40 |
| 2 | NW/1 | ½ osy | 15.59 | 14.95 | 14.54 | 14.61 | 14.54 | 14.85 |
| 3 | NW/2 | ½ osy | 22.49 | 21.23 | 20.36 | 19.72 | 20.59 | 20.88 |
| 4 | NW/1 | 1 osy | 17.43 | 17.78 | 17.81 | 17.26 | 16.75 | 17.41 |
| 5 | NW/1 | ½ osy | 16.64 | 15.80 | 15.22 | 15.39 | 15.45 | 15.70 |

Table 9

Adhesive strength of TM13C/NW/1 and TM13C/NW/2 ASTM International Standard D 4541

| | | | | Adhesion (Ibf) | | | | |
|---|---|---|---|---|---|---|---|---|
| Sample ID | TM13C/NW/1 and NW/2 | Adhesive Weight (osy) | MD/CD | SIDE | Sample #1 | Sample #2 | Sample #3 | Sample #4 |
| 1 | NW/2 | 1 osy | MD | FRONT | 1.48 | 1.16 | 0.88 | 0.82 |
| | | | MD | BACK | 0.99 | 0.84 | 1.07 | 2.50 |
| | | | CD | FRONT | 0.94 | 1.14 | 0.97 | 1.04 |
| | | | CD | BACK | 1.26 | 1.60 | 0.88 | 0.98 |
| 2 | NW/1 | ½ osy | MD | --- | 1.02 | 1.18 | 1.06 | 1.13 |
| | | | CD | --- | 1.70 | 1.43 | 1.63 | 1.16 |
| 3 | NW/2 | ½ osy | MD | FRONT | 1.10 | 1.17 | 1.28 | 1.18 |
| | | | MD | BACK | 1.14 | 0.94 | 0.92 | 1.32 |
| | | | CD | FRONT | 0.44 | 1.19 | 1.20 | 1.34 |
| | | | CD | BACK | 2.23 | 1.33 | 1.18 | 1.73 |
| 4 | NW/1 | 1 osy | MD | --- | 1.22 | 1.05 | 1.15 | 1.03 |
| | | | CD | --- | 1.89 | 1.95 | 1.38 | 1.49 |
| 5 | NW/1 | ½ osy | MD | --- | 1.19 | 1.34 | 1.18 | 1.02 |
| | | | CD | --- | 1.06 | 1.46 | 1.52 | 1.23 |

Table 9

(continued).

| | | | | Adhesion (Ibf) | | | | |
|---|---|---|---|---|---|---|---|---|
| Sample ID | TM13C/NW/1 and NW/2 | Adhesive Weight (osy) | MD/CD | SIDE | Sample #5 | Sample #6 | Sample #7 | Sample #8 |
| 1 | NW/2 | 1 osy | MD | FRONT | 0.89 | 0.93 | 0.88 | 0.86 |
| | | | MD | BACK | 0.91 | 1.00 | 0.95 | --- |
| | | | CD | FRONT | 1.39 | 1.50 | 1.25 | 2.01 |
| | | | CD | BACK | 1.24 | 0.93 | 0.92 | 0.97 |
| 2 | NW/1 | ½ osy | MD | --- | 1.13 | 1.21 | 1.25 | 1.20 |
| | | | CD | --- | 1.25 | 1.56 | 2.43 | 1.91 |
| 3 | NW/2 | ½ osy | MD | FRONT | 0.99 | 1.23 | 0.89 | 1.03 |
| | | | MD | BACK | 0.99 | 1.00 | 0.85 | 1.03 |
| | | | CD | FRONT | 1.17 | 1.45 | 1.45 | 2.02 |
| | | | CD | BACK | 1.14 | 1.22 | 2.02 | 1.20 |
| 4 | NW/1 | 1 osy | MD | --- | 1.59 | 1.34 | 1.35 | 1.18 |
| | | | CD | --- | 0.93 | 1.75 | 0.98 | 1.59 |
| 5 | NW/1 | ½ osy | MD | --- | 0.95 | 1.05 | 0.83 | 0.91 |
| | | | CD | --- | 1.09 | 0.97 | 1.06 | 0.94 |

Table 9

(continued).

| | | | | Adhesion (Ibf) | | | | |
|---|---|---|---|---|---|---|---|---|
| Sample ID | TM13C/NW/1 and NW/2 | Adhesive Weight (osy) | MD/CD | SIDE | Sample #9 | SIDE AVG | ROLL AVG | Air Flow (ASTM D737) |
| 1 | NW/2 | 1 osy | MD | FRONT | 0.90 | 0.98 | 1.12 | 223 CFM |
| | | | MD | BACK | --- | 1.18 | | |
| | | | CD | FRONT | --- | 1.28 | | |
| | | | CD | BACK | 1.00 | 1.09 | | |
| 2 | NW/1 | ½ osy | MD | --- | 1.47 | 1.18 | 1.38 | 477 CFM |
| | | | CD | --- | 1.19 | 1.58 | | |
| 3 | NW/2 | ½ osy | MD | FRONT | 1.16 | 1.11 | 1.24 | 271 CFM |
| | | | MD | BACK | 1.02 | 1.02 | | |
| | | | CD | FRONT | 1.25 | 1.28 | | |
| | | | CD | BACK | 1.75 | 1.53 | | |
| 4 | NW/1 | 1 osy | MD | --- | 1.05 | 1.22 | 1.33 | 483 CFM |
| | | | CD | --- | 1.09 | 1.45 | | |
| 5 | NW/1 | ½ osy | MD | --- | --- | 1.06 | 1.11 | 612 CFM |
| | | | CD | --- | | | | |

As shown in Table 9, TM13C either with NW/1 or NW/2 shows a tensile peel strength between about 1.1 pounds force (lbf) to about 1.4 pounds force.

### Example 4

Various materials were tested for hydraulic transmissivity, as measured in accordance with ASTM International Standard D 4716.

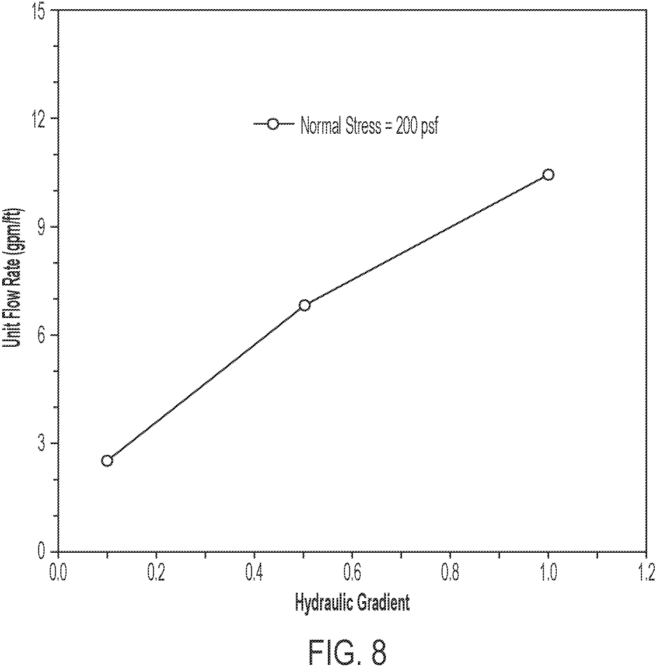

FIG. 8 and Table 10 shows the results of hydraulic transmissivity testing using ASTM D 4716 testing method for a single layer 160N nonwoven geotextile/TM13C erosion control mat.

Table 10

Hydraulic transmissivity testing of TM13C/NW/1 using ASTM D 4716

| Test Cross-Section from Top to Bottom | Normal Stress (psf) | Seating Time (hour) | Hydraulic Gradient (i) (-) | Transmissivity 8 (m²/sec) | Unit Flow Rate (q) (gpm/ft) |
|---|---|---|---|---|---|
| Steel Plate Single layer of 160N Nonwoven Geotextile TM13C erosion control mat Steel Plate Test Specimen: 12" long by 12" wide. | 200 | 0.25 | 0.1 | 5.17E-03 | 2.50 |
| | 200 | 0.25 | 0.5 | 2.81E-03 | 6.80 |
| | 200 | 0.25 | 1.0 | 2.15E-03 | 10.40 |

As shown in Table 10 and FIG. 8, the 3D composite fabric with a single nonwoven layer, TM13C/NW/1, retains about 58% thickness (see Table 2, TMC/NW/1), shows improved transmissivity of at least 1 gallon per square foot per minute (g/sf/min) at 0.1 gradient at 200 pounds per square foot as measured in accordance with ASTM D 4716, that is, transmissivity of at least 2.07×10⁻³ m²/sec at 0.1 gradient at 200 pounds per square foot as measured in accordance with ASTM D 4716 (see [0101]), illustrating that while not having the higher thickness retention compared to nonwoven fabrics after compression (Table 2, S600) the composite fabric still maintains adequate voids within its structure to allow improved transmissivity while preventing soil migration.

Even though 3D woven fabrics (Table 2, 58600 and 58209) show higher % thickness retention compared to the 3D composite fabrics (Table 2, TMC13/NW/1 and TMC13/NW/2), without nonwoven layer, they will fail to separate particles from migrating and clogging the fabric. Therefore, the 3D composite fabrics show improved transmissivity while not having the higher thickness retention after compression as they still maintain adequate voids within the structure to allow transmissivity while preventing soil migration.

### Example 5

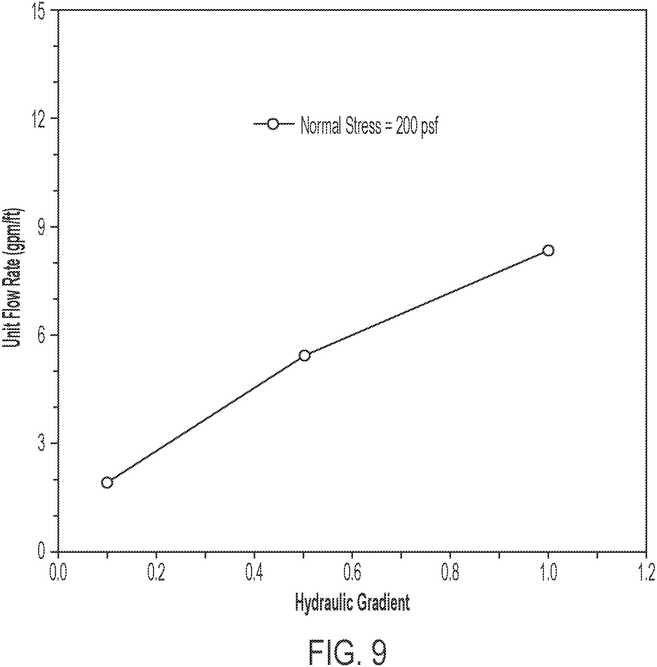

FIG. 9 and Table 11 shows the results of hydraulic transmissivity testing using ASTM D 4716 testing method for TM13C/NW/2 Geotextile.

Table 11

Hydraulic transmissivity testing of TM13C/NW/2 using ASTM D 4716

| | | | | | |
|---|---|---|---|---|---|
| Test Cross-Section from Top to Bottom | Normal Stress (psf) | Seating Time (hour) | Hydraulic Gradient (i) (-) | Transmissivity 8 (m²/sec) | Unit Flow Rate (q) (gpm/ft) |
| Steel Plate | 200 | 0.25 | 0.1 | 3.93E-03 | 1.90 |
| Single layer of 160N | 200 | 0.25 | 0.5 | 2.24E-03 | 5.40 |
| Nonwoven Geotextile | 200 | 0.25 | 1.0 | 1.72E-03 | 8.30 |
| TM13C erosion control mat Steel Plate | | | | | |
| Test Specimen: 12" long by | | | | | |
| 12" wide. | | | | | |

As shown in Table 11 and FIG. 9, the 3D composite fabric with two nonwoven layers, one on each side, TMC13/NW/2, retains about 61% thickness (see Table 2, TMC13/NW/2) and also shows improved transmissivity and radial flow rate of at least 1 gallon per square foot per minute (g/sf/min) at 0.1 gradient at 200 pounds per square foot as measured in accordance with ASTM D 4716, that is, transmissivity of at least 2.07x10⁻³ m²/sec at 0.1 gradient at 200 pounds per square foot as measured in accordance with ASTM D 4716.

### Example 6

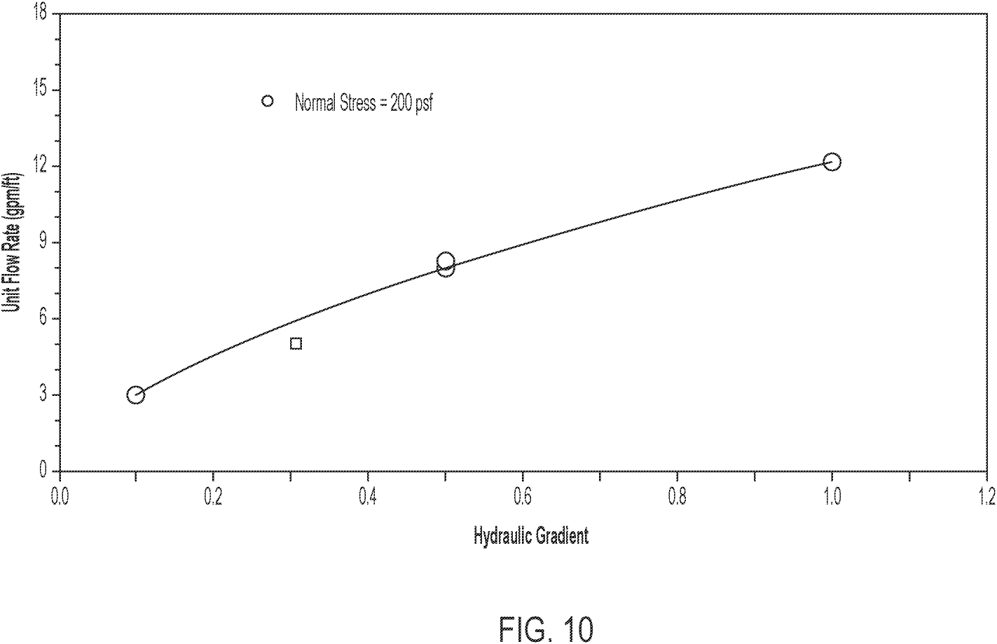

FIG. 10 and Table 12 shows the results of hydraulic transmissivity testing using ASTM D 4716 testing method for a TM13C/NW/1

Table 12

Hydraulic transmissivity testing of TM13C/NW/1 using ASTM D 4716

| Test Cross-Section from Top to Bottom | Test No. ( - ) | Normal Stress (psf) | Seating Time (hour) | Hydraulic Gradient i ( - ) | Transmissivity θ (m²/sec) | Flow Rate q (gpm/ft) | Average Transmissivity (m²/sec) | Average Flow Rate (gpm/ft) |
|---|---|---|---|---|---|---|---|---|
| Steel Plate | 1 | 200 | 0.25 | 0.1 | 6.13E-03 | 2.96 | 6.10E-03 | 2.95 |
| 6 oz NWGT/TM13C mat (single sided composite) | 2 | 200 | 0.25 | 0.1 | 6.06E-03 | 2.93 | | |
| | 1 | 200 | 0.25 | 0.5 | 3.29E-03 | 7.94 | 3.34E-03 | 8.08 |
| Steel Plate | 2 | 200 | 0.25 | 0.5 | 3.40E-03 | 8.22 | | |
| | 1 | 200 | 0.25 | 1.0 | 2.50E-03 | 12.08 | 2.51E-03 | 12.11 |
| Test Specimen: 12" long by 12" wide | 2 | 200 | 0.25 | 1.0 | 2.51E-03 | 12.13 | | |

As shown in Table 12 and FIG. 10, the 3D composite fabric with a single nonwoven layer, /TM13C/NW/1, retains about 58% thickness (see Table 2, TMC13/NW/1) and also shows improved transmissivity and radial flow rate of at least 1 gallon per square foot per minute (g/sf/min) at 0.1 gradient at 200 pounds per square foot as measured in accordance with ASTM D 4716, that is, transmissivity of at least 2.07x10⁻³ m²/sec at 0.1 gradient at 200 pounds per square foot as measured in accordance with ASTM D 4716.

### Example 7

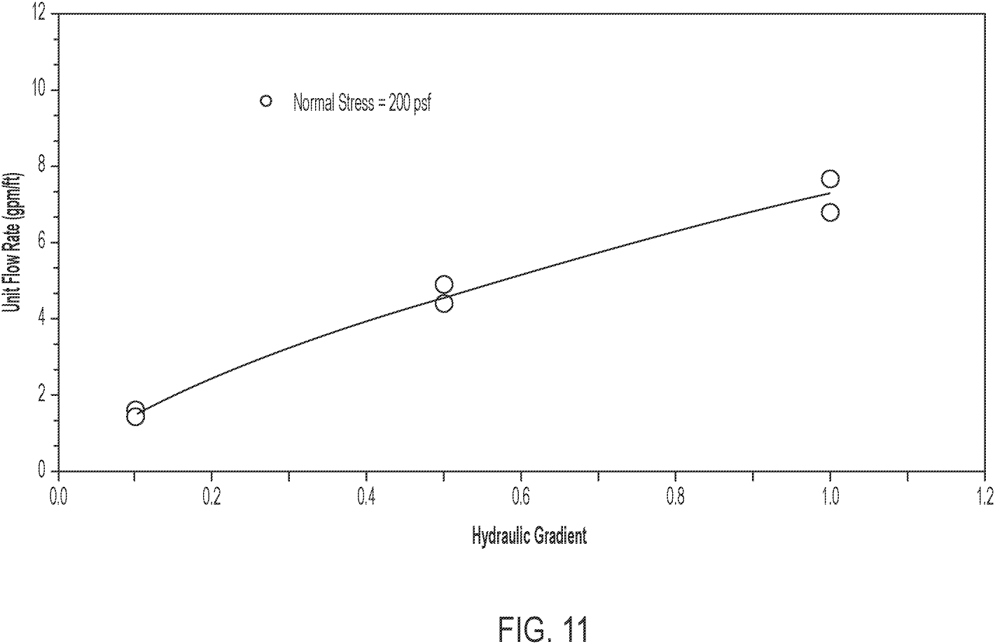

FIG. 11 and Table 13 shows the results of hydraulic transmissivity testing using ASTM D 4716 testing method for a 6 oz /TM13C/NW/2

Table 13

Hydraulic and transmissivity testing of TM13C/NW1 using ASTM D 4716

| Test Cross-Section from Top to Bottom | Test No. ( - ) | Normal Stress (psf) | Seating Time (hour) | Hydraulic Gradient i ( - ) | Transmissivity θ (m²/sec) | Flow Rate q (gpm/ft) | Average Transmissivity (m²/sec) | Average Flow Rate (gpm/ft) |
|---|---|---|---|---|---|---|---|---|
| Steel Plate | 1 | 200 | 0.25 | 0.1 | 3.37E-03 | 1.63 | 3.19E-03 | 1.54 |
| 6 oz NWGT/TM13C mat/6 oz | 2 | 200 | 0.25 | 0.1 | 3.00E-03 | 1.45 | | |
| NWGT/ (double sided composite) | 1 | 200 | 0.25 | 0.5 | 2.04E-03 | 4.92 | 1.94E-03 | 4.68 |
| | 2 | 200 | 0.25 | 0.5 | 1.83E-03 | 4.43 | | |
| Steel Plate | 1 | 200 | 0.25 | 1.0 | 1.59E-03 | 7.66 | 1.50E-03 | 7.26 |
| | 2 | 200 | 0.25 | 1.0 | 1.42E-03 | 6.85 | | |
| Test Specimen: 12" long by 12" wide | | | | | | | | |

As shown in Table 13 and FIG. 11, the 3D composite fabric with a double nonwoven layer, TM13C/NW/2, retains about 61% thickness (see Table 2, TMC13/NW/2), shows improved transmissivity and radial flow rate of at least 1 gallon per square foot per minute (g/sf/min) at 0.1 gradient at 200 pounds per square foot as measured in accordance with ASTM D 4716, that is, transmissivity of at least 2.07x10⁻³ m²/sec at 0.1 gradient at 200 pounds per square foot as measured in accordance with ASTM D 4716.

### Comparative Example 1

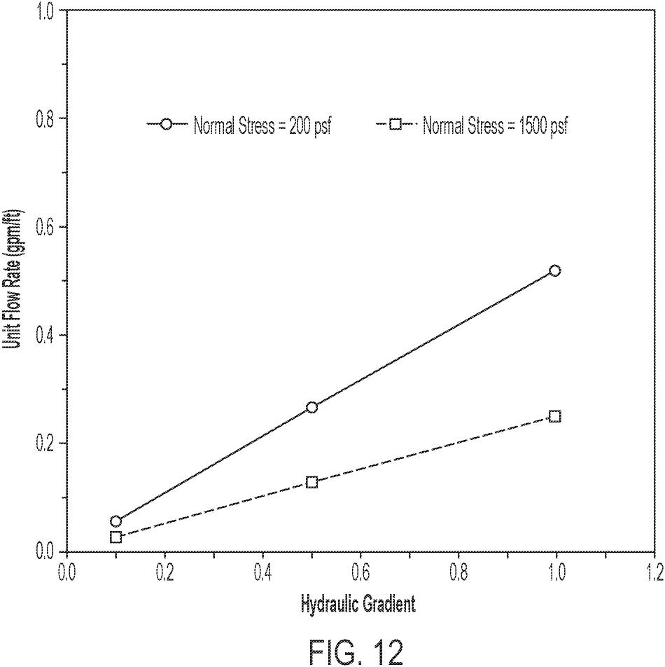

FIG. 12 and Table 14 shows the results of hydraulic transmissivity testing using ASTM D 4716 testing method for KEC1200/NW/1.

Table 14

Hydraulic transmissivity testing of the KEC1200/NW/1 using ASTM D 4716

| Test Cross-Section from Top to Bottom | Normal Stress (psf) | Seating Time (hour) | Hydraulic Gradient i ( - ) | Transmissivit y \| \| (m2/sec) | Unit Flow Rate q (gpm/ft) |
|---|---|---|---|---|---|
| Steel Plate | 200 | 0.25 | 0.1 | 1.18E-04 | 0.06 |
| Single layer of KEC 1200 Nonwoven | 200 | 0.25 | 0.5 | 1.12E-04 | 0.27 |
| Geotextile Steel Plate | 200 | 0.25 | 1.0 | 1.08E-04 | 0.52 |
| | 1500 | 0.25 | 0.1 | 5.80E-05 | 0.03 |
| Test Specimen: 12" long by 12" wide. | 1500 | 0.25 | 0.5 | 5.38E-05 | 0.13 |
| | 1500 | 0.25 | 1.0 | 5.17E-05 | 0.25 |

As shown in Table 14 and FIG. 12, the KEC1200/NW/1 shows transmissivity and radial flow rate less than 1 gallon per square foot per minute (g/sf/min) at 0.1 gradient at 200 pounds per square foot as measured in accordance with ASTM D 4716 (1 gallon per square foot per minute = 2.07x10⁻³ m²/sec, see [0101]). KEC1200 is same as SFM2000, except that SFM2000 is stitched and KEC1200 is not (see Table 1). As shown in Table 2, SFM2000 retains high % thickness at 200 psf compression (about 89%), but even after retaining such a high % thickness KEC1200, which is equivalent to SFM2000 shows low transmissivity and radial flow rate (less than 1 gallon per square foot per minute (g/sf/min) at 0.1 gradient at 200 pounds per square foot as measured in accordance with ASTM D 4716).

Even though nonwoven fabrics (SFM and KEC) show high % thickness retained under compression compared to Examples 4-7, they fail to achieve transmissivity and radial flow rate of at least 1 gallon per square foot per minute (g/sf/min) at 0.1 gradient at 200 pounds per square foot as measured in accordance with ASTM D 4716, illustrating advantage of having the 3D composite fabric with a 3D woven and nonwoven fabric.

### Comparative Example 2

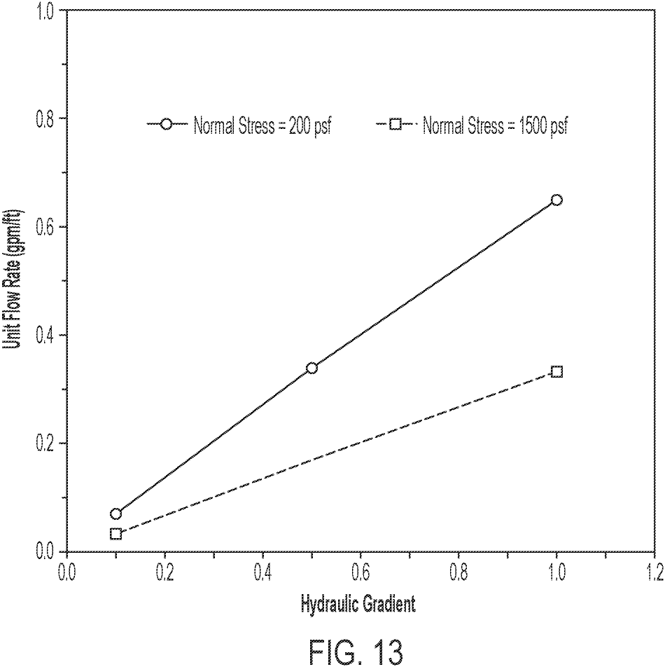

FIG. 13 and Table 15 shows the results of hydraulic transmissivity testing using ASTM D 4716 testing method for a KEC1200/NW/2 Nonwoven Geotextile.

Table 15

Hydraulic transmissivity testing of a KEC1200/NW/2 using ASTM D 4716

| Test Cross-Section from Top to Bottom | Normal Stress (psf) | Seating Time (hour) | Hydraulic Gradient i ( - ) | Transmissivity ε (m²/sec) | Unit Flow Rate q (gpm/ft) |
|---|---|---|---|---|---|
| Steel Plate | 200 | 0.25 | 0.1 | 1.45E-04 | 0.07 |
| Double layer of KEC 1200 Nonwoven | 200 | 0.25 | 0.5 | 1.41E-04 | 0.34 |
| Geotextile Steel Plate | 200 | 0.25 | 1.0 | 1.35E-04 | 0.65 |
| | 1500 | 0.25 | 0.1 | 7.04E-05 | 0.03 |
| Test Specimen: 12" long by 12" wide. | 1500 | 0.25 | 0.5 | 7.04E-05 | 0.17 |
| | 1500 | 0.25 | 1.0 | 6.91E-05 | 0.33 |

As shown in Table 15 and FIG. 13, the Double layer KEC1200 also shows transmissivity and radial flow rate less than 1 gallon per square foot per minute (g/sf/min) at 0.1 gradient at 200 pounds per square foot as measured in accordance with ASTM D 4716. That is, thick nonwoven do not perform well illustrating that retention of high % thickness is not enough for achieving improved transmissivity.

### Comparative Example 3

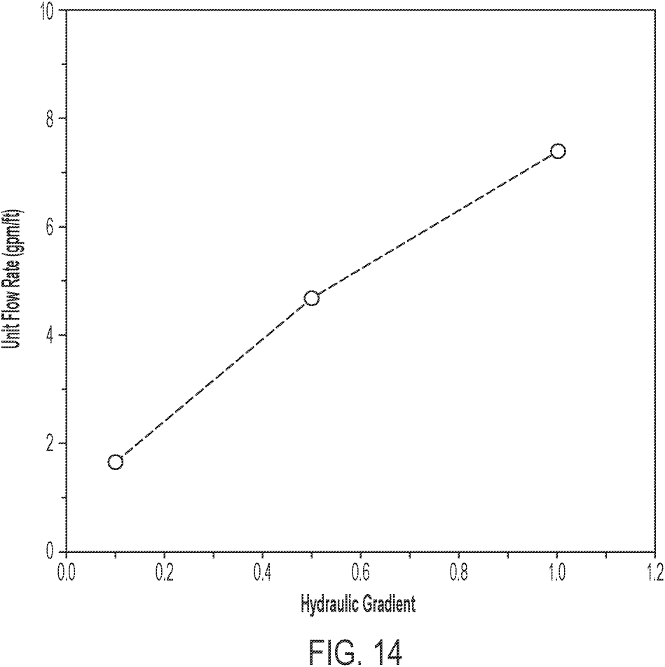

As shown in Table 16 and FIG. 14, the 3D composite fabric (White Honeycomb Woven Mesh 58600) with a single nonwoven layer attached, 58600/NW/1, has a transmissivity and radial flow rate of 1.64 gallon per square foot per minute (g/sf/min) at 0.1 gradient at 200 pounds per square foot as measured in accordance with ASTM D 4716. However, this flow rate falls far below the flow rate for TM13C/NW/1 (2.50 or 2.95 gallon per square foot per minute (g/sf/min) at 0.1 gradient at 200 pounds per square foot as measured in accordance with ASTM D 4716, see Table 10 and 12) under similar conditions.

Table 16

Hydraulic transmissivity testing of 58600/NW/1 using ASTM D 4716

| | | | | | |
|---|---|---|---|---|---|
| Test Cross-Section from Top to Bottom | Normal Stress (psf) | Seating Time (hour) | Hydraulic Gradient ( i ) ( - ) | Transmissivity 8 (m²/sec) | Unit Flow Rate (q) (gpm/ft) |
| Steel Plate | 200 | 0.25 | 0.1 | 3.40E-03 | 1.64 |
| Nonwoven Geotextile | 200 | 0.25 | 0.5 | 1.94E-03 | 4.69 |
| White Honeycomb Woven mesh #58600 | 200 | 0.25 | 1.0 | 1.53E-03 | 7.40 |
| Steel Plate | | | | | |
| Test Specimen: 12" long by | | | | | |
| 12" wide. | | | | | |

### Comparative Example 4

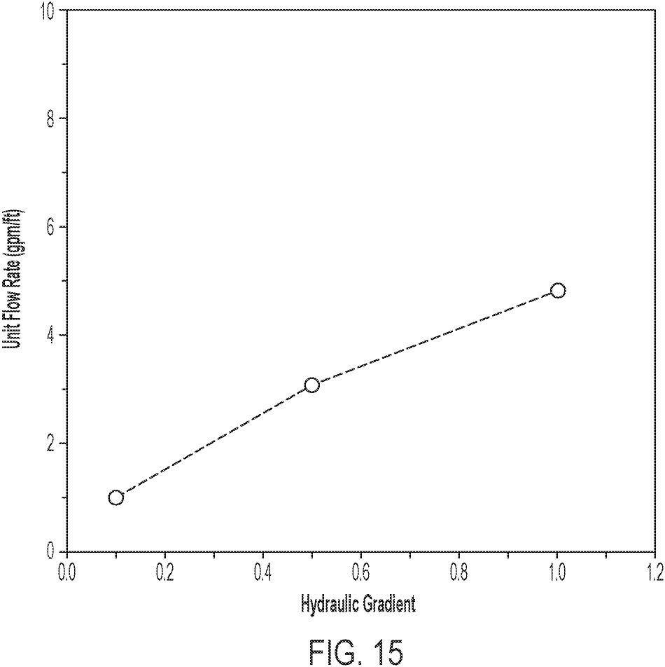

As shown in Table 17 and FIG. 15, the 3D composite fabric (White Honeycomb Woven Mesh 58600) with two nonwoven layers on each side, 58600/NW/2, on each side shows transmissivity of less than 1 gallon per square foot per minute (g/sf/min) at 0.1 gradient at 200 pounds per square foot as measured in accordance with ASTM D 4716, that is, transmissivity of less than 2.07x 10⁻³ m²/sec at 0.1 gradient at 200 pounds per square foot as measured in accordance with ASTM D 4716.

Table 17

Hydraulic transmissivity testing of 58600/NW/2 using ASTM D 4716

| Test Cross-Section from Top to Bottom | Normal Stress (psf) | Seating Time (hour) | Hydraulic Gradient ( i ) ( - ) | Transmissivity 8 (m²/sec) | Unit Flow Rate (q) (gpm/ft) |
|---|---|---|---|---|---|
| Steel Plate | 200 | 0.25 | 0.1 | 1.97E-03 | 0.95 |
| Nonwoven Geotextile | 200 | 0.25 | 0.5 | 1.26E-03 | 3.05 |
| White Honeycomb Woven mesh 58600 | 200 | 0.25 | 1.0 | 9.93E-04 | 4.80 |
| Steel Plate | | | | | |
| Test Specimen: 12" long by | | | | | |
| 12" wide. | | | | | |

As shown by Examples 4-7, and Comparative Examples 1-4, the composite fabrics with a single or a double layer of nonwoven fabric, shows transmissivity of less than 1 gallon per square foot per minute (g/sf/min) at 0.1 gradient at 200 pounds per square foot as measured in accordance with ASTM D 4716 while preventing soil migration compared to the single or double layered nonwoven.

As shown in Table 18, TM13C either with a single nonwoven layer, NW/1, or with a double nonwoven layers, one on each side, NW/2, show improved transmissivity and flow rate of at least 1 gallon per square foot per minute (g/sf/min) at 0.1 gradient at 200 pounds per square foot as measured in accordance with ASTM D 4716 compared to other fabrics like KEC1200 and 58600 under the same conditions. This illustrates that 3D composite fabrics, that retain inter-void space under load, for example, TM13C, perform better compared to thicker fabrics like KEC1200 and 58600.

Table 18

Comparison of hydraulic transmissivity testing data using ASTM D 4716

| Sr. No. | Material | Normal Stress (psf) | Hydraulic Gradient (i) | Unit Flow Rate (q) (gpm/ft) | Transmissivity 8 (m²/sec) |
|---|---|---|---|---|---|
| 1 | KEC1200/NW/1 | 200 | 0.1 | 0.06 | --- |
| 2 | KEC1200/NW/2 | 200 | 0.1 | 0.07 | --- |
| 3 | TM13C/NW/1 | 200 | 0.1 | 2.50 | 5.17E-03 |
| 4 | TM13C/NW/2 | 200 | 0.1 | 1.90 | 3.93E-03 |
| 5 | TM13C/NW/1 with adhesive | 200 | 0.1 | 2.95 | 6.10E-03 |
| 6 | TM13C/NW/2 with adhesive | 200 | 0.1 | 1.54 | 3.19E-03 |
| 7 | 58600 | 200 | 0.1 | 1.10 | --- |
| 8 | 58600/NW/1 | 200 | 0.1 | 1.64 | 3.40E-03 |
| 9 | 58600/NW/2 | 200 | 0.1 | 0.95 | 1.97E-03 |

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, various modifications may be made of the invention without departing from the scope thereof and it is desired, therefore, that only such limitations shall be placed thereon as are imposed by the prior art and which are set forth in the appended claims.

What is claimed is:

1. A three-dimensional composite fabric comprising:
a three-dimensional woven fabric comprising:
a first layer comprising monofilaments respectively woven in warp and fill directions; and
an optional second layer comprising monofilaments respectively woven in warp and fill directions and having a first side and a second side; and
a nonwoven fabric arranged on a first side, on a second side, or on both sides of the three-dimensional woven fabric;
wherein the three-dimensional composite fabric retains at least 15% thickness at a compression of about 200 pounds per square foot (psf) to about 1000 pounds per square foot; has a water transmissivity of at least 1 gallon per square feet per minute (g/sf/min) at 0.1 gradient at 200 pounds per square foot as measured in accordance with American Society for Testing and Materials International (ASTM International) Standard D 4716; or has a combination thereof.

2. The three-dimensional composite fabric of claim 1, wherein an adhesive is arranged between the three-dimensional woven fabric and the nonwoven fabric.

3. The three-dimensional composite fabric of claim 2, wherein the adhesive has a softening point of about 150° F. to about 350° F., or a softening point of about 244° F. to about 252° F.

4. The three-dimensional composite fabric of claim 2, wherein the adhesive is an amorphous polyolefin adhesive.

5. The three-dimensional composite fabric of claim 2, wherein the adhesive is a sprayable latex, a polyalphaolefin, an ethylene vinyl acetate, a polypropylene, a polyethylene, a polypropylene and polyethylene blend, a polyvinyl acetate, an epoxy resin, a hot melt adhesive, an acrylate, an amorphous polyolefin, a thermoplastic olefin, or a combination thereof.

6. The three-dimensional composite fabric of claim 1, wherein the first layer is over and under woven through the second layer in a pattern such that the first layer has portions that face the first side of the second layer, and portions that face the second side of the second layer, and cells are disposed on the first side and the second side of the second layer and respectively defined by the pattern of the over and under weave of the first layer, and each cell defines a permeable, enclosed cavity.

7. The three-dimensional composite fabric of claim 6, wherein each cell has a portion of the first layer that is spaced apart from a portion of the second layer.

8. The three-dimensional composite fabric of claim 6, wherein each cell has a length in the warp direction of about 0.40 inches to about 1.3 inches and a width in the fill direction of about 0.40 inches to about 1.3 inches, and measurements of the length and width of the cell are same or different.

9. The three-dimensional composite fabric of claim 1, wherein the monofilaments are polyamides, polyimides, polyesters, polyacrylonitriles, polyphenylene oxides, fluoropolymers, acrylics, polyolefins, polyphenylene sulfide, polyetherimide, polyetheretherketone, polylactic acid, aramids, aromatic ether ketones, vinalon, or any combination thereof.

10. The three-dimensional composite fabric of claim 1, wherein the monofilaments include natural fibers.

11. The three-dimensional composite fabric of claim 1, wherein the monofilaments in the warp direction of the first layer comprise polyethylene, and the monofilaments in the warp direction of the second layer comprise polypropylene.

12. The three-dimensional composite fabric of claim 1, wherein the three-dimensional composite fabric retains about 35% to about 95% thickness at the compression of about 200 pounds per square foot.

13. The three-dimensional composite fabric of claim 1, wherein the three-dimensional composite fabric retains about 20% to about 85% thickness at a compression of about 500 pounds per square foot, or about 15% to about 70% thickness at a compression of about 1000 pounds per square foot.

14. The three-dimensional composite fabric of claim 1, wherein the three-dimensional composite fabric has:
a water flow rate of about 0.01 gallons per minute/foot (gpm/ft) to about 15 gallons per minute/foot, as measured in accordance with American Society for Testing and Materials International (ASTM International) Standard D 4716;
a water transmissivity of at least 1 gallon per square feet per minute (g/sf/min) at 0.1 gradient at 200 pounds per square foot as measured in accordance with American Society for Testing and Materials International (ASTM International) Standard D 4716;
or the water flow rate and the water transmissivity.

15. The three-dimensional composite fabric of claim 1, wherein the three-dimensional composite fabric has:
an air flow rate of about 10 cubic feet per minute (cfm) to about 1000 cubic feet/minute as measured in accordance with American Society for Testing and Materials International (ASTM International) Standard D 737;
an air flow rate of about 150 cubic feet per minute to about 700 cubic feet/minute as measured in accordance with American Society for Testing and Materials International (ASTM International) Standard D 737;
air flow rate of about 50 cubic feet per minute to about 400 cubic feet per minute as measured in accordance with American Society for Testing and Materials International (ASTM International) Standard D 737;
or a combination of the air flow rates.

16. The three-dimensional composite fabric of claim 1, wherein the nonwoven fabric comprises polypropylene fibers, polyethylene fibers, or a combination thereof.

17. The three-dimensional composite fabric of claim 1, further comprising another nonwoven fabric arranged on a side opposite the nonwoven fabric.

18. The three-dimensional composite fabric of claim 1, wherein the three-dimensional woven fabric has a thickness of about 150 mils to about 750 mils.

19. The three-dimensional composite fabric of claim 1, wherein the three-dimensional composite fabric comprises a shrinker fabric, a non-shrinker fabric, or a combination thereof.

20. A method of making a three-dimensional composite fabric, the method comprising:
arranging a nonwoven fabric on a first side, on a second side, or on both sides of a three-dimensional woven fabric, the three-dimensional woven fabric comprising:
a first layer comprising monofilaments woven in warp and fill directions; and
an optional second layer comprising monofilaments woven in warp and fill directions and having a first side and a second side, the first layer being over and under woven through the second layer in a pattern such that the first layer has portions that face the first side of the second layer and portions that face the second side of the second layer, and cells being disposed on the first side and the second side of the second layer and respectively defined by the pattern of the over and under weave of the first layer, and each cell defining a permeable, enclosed cavity.

21. The method of claim 20, wherein the method further comprises applying an adhesive to either the three-dimensional woven fabric or the nonwoven fabric; and adhering the 3D woven fabric to the nonwoven fabric such that the adhesive is arranged therebetween to form the 3D composite fabric.

22. The method of claim 21, wherein the adhesive has a softening point of about 150° F. to about 350° F.; a softening point of about 244° F. to about 252° F.; or a combination thereof.

23. The method of claim 21, wherein the adhesive is a polyolefin adhesive.

24. The method of claim 21, wherein the adhesive is a sprayable latex, a polyalphaolefin, an ethylene vinyl acetate, a polypropylene, a polyethylene, a polypropylene and polyethylene blend, a polyvinyl acetate, an epoxy resin, an acrylate, an amorphous polyolefin, a thermoplastic olefin, or a combination thereof.

25. The method of claim 20, wherein the three-dimensional composite fabric:
retains at least 15% thickness at a compression of about 200 pounds per square foot (psf) to about 1000 pounds per square foot; retains about 35% to about 95% thickness at a compression of about 200 pounds per square foot;
retains about 20% to about 85% thickness at a compression of about 500 pounds per square foot;
retains about 15% to about 70% thickness at a compression of about 1000 pounds per square foot;
or a combination thereof.

26. The method of claim 20, wherein each cell has a portion of the first layer that is spaced apart from a portion of the second layer.

27. The method of claim 20, wherein the monofilaments are polyamides, polyimides, polyesters, polyacrylonitriles, polyphenylene oxides, fluoropolymers, acrylics, polyolefins, polyphenylene sulfide, polyetherimide, polyetheretherketone, polylactic acid, aramids, aromatic ether ketones, vinalon, or any combination thereof.

28. The method of claim 20, wherein the monofilaments comprise natural fibers.

29. The method of claim 20, wherein the monofilaments in the warp direction of the first layer comprise polyethylene, and the monofilaments in the warp direction of the second layer comprise polypropylene.

30. The method of claim 20, wherein the three-dimensional composite fabric has:
a water flow rate of about 0.01 gallons per minute/foot (gpm/ft) to about 15 gallons per minute/foot, as measured in accordance with American Society for Testing and Materials International (ASTM International) Standard D 4716;
a water transmissivity of at least 1 gallon per square feet per minute (g/sf/min) at 0.1 gradient at 200 pounds per square foot as measured in accordance with American Society for Testing and Materials International (ASTM International) Standard D 4716. ;
an air flow rate of about 100 cubic feet per minute (cfm) to about 1000 cubic feet/minute as measured as measured in accordance with American Society for Testing and Materials International (ASTM International) Standard D 737;
or a combination thereof.

31. The method of claim 20, wherein the nonwoven fabric comprises polypropylene fibers, polyethylene fibers, or a combination thereof.

32. The method of claim 20, wherein each cell has a length in the warp direction of about 0.40 inches to about 1.3 inches and a width in the fill direction of about 0.40 inches to about 1.3 inches, and measurements of the length and width of each cell are the same or different.

33. The method of claim 20, wherein the method further comprises arranging another nonwoven fabric on a side opposite the nonwoven fabric.

34. The method of claim 20, wherein the three-dimensional woven fabric has a thickness of about 150 mils to about 750 mils.

35. A method of installing a three-dimensional composite fabric, the method comprising:
arranging the three-dimensional composite fabric adjacent to a second three-dimensional composite fabric, the three-dimensional composite fabric, the second three-dimensional fabric, or both, comprising:
a three-dimensional woven fabric comprising:
a first layer comprising monofilaments respectively woven in warp and fill directions; and
an optional second layer comprising monofilaments respectively woven in warp and fill directions and having a first side and a second side; and
a nonwoven fabric arranged on a first side, on a second side, or on both sides of the three-dimensional woven fabric;
wherein the three-dimensional composite fabric retains at least 15% thickness at a compression of about 200 pounds per square foot (psf) to about 1000 pounds per square foot;
heating portions of the three-dimensional composite fabric and the second three-dimensional composite fabric to join the three-dimensional composite fabric to the second three-dimensional composite fabric and form a joined three-dimensional composite fabric; and
disposing the joined three-dimensional composite fabric in a landfill.

36. The method of claim 35, wherein the joined three-dimensional composite fabric is disposed on a top of a landfill, on a bottom of a landfill, or a bottom of a pond.

37. The method of claim 35, wherein the joined three-dimensional composite fabric is joined by wedge welding.

38. The method of claim 37, wherein a wedge weld strength of the joined three-dimensional composite fabric is about 50 pound per inch to about 125 pound per inch when tested according to ASTM D4884 test method.
